(19) United States
(12) Patent Application Publication
(10) Pub. No.: US 2002/0082994 A1
(43) Pub. Date: Jun. 27, 2002

(54) Method and apparatus for managing automated banking machines

(75) Inventor: Kathy Ann Herziger, Sheboygan Falls, WI (US)

Correspondence Address: MICHAEL BEST & FRIEDRICH, LLP, 100 E WISCONSIN AVENUE, MILWAUKEE, WI, 53202, US

(73) Assignee: eFunds Corporation, Milwaukee, WI

(21) Appl. No.: 09/970,149

(22) Filed: Oct. 2, 2001

Related U.S. Application Data
(60) Provisional application No. 60/237,306, filed on Oct. 2, 2000.
(60) Provisional application No. 60/237,907, filed on Oct. 4, 2000.

(51) Int. Cl. G06F 17/60

(52) U.S. Cl. 705/43

(57) ABSTRACT

In some preferred embodiments of the present invention, an ATM management application is used to provide an ATM operator with a comprehensive set of ATM management information. This ATM management information can enable the ATM operator to increase ATM profitability through improved ATM availability and expense reduction. The ATM management application can include any number of the following modules: a currency management module, a status inquiry module, a courier services module, an auto balance module, a deposit verification module, and a site analysis and profitability management module.

### FIELD OF THE INVENTION

The present invention relates generally to automated banking machines, and more particularly, to management of automated banking machines.

### BACKGROUND OF THE INVENTION

Automated banking machines have rapidly taken a key role in worldwide banking and financial transactions. Therefore, the importance of efficiently and effectively managing such banking machines continues to grow. One well-known form of automated banking machine is the automated teller machine (hereinafter “ATM”). ATMs enable customers to carry out financial transactions including deposits, transfers of funds between accounts, bill payments, balance inquiries, currency withdrawals, and the like. A point of sale (“POS”) device is another type of an automated banking machine that is commonly used. POS devices enable customers to carry out transactions including debits and credits against accounts (e.g., checking accounts, savings accounts, credit card accounts, and the like). Other types of automated banking machines include devices that print and/or dispense items of value such as coupons, tickets, wagering slips, vouchers, checks, food stamps, postage, money orders, and other items of value (all of which are referred to herein as “currency”). As used herein, the term ATM shall encompass any type of automated banking machine that carries out transactions partially or fully, including those for transfers of value.

ATMs are typically placed at locations where ATM customers can quickly and conveniently carry out transactions including transfers of value. These locations may include financial institutions, food retailers, convenience stores, service stations, restaurant, diners, nightclubs, hotels, motels, liquor stores, thrift stores, airports, sports stadiums, pharmacies, and the like. The entities that operate ATMs (i.e., ATM operators) include financial institutions and entrepreneurs. ATM operators often also own the ATMs. In other cases, ATMs are owned by a first entity (e.g., a financial institution) and operated by a second entity such as a service provider that is contracted by the first entity. In this case, the service provider is the ATM operator.

ATM operators place ATMs in locations where customers can quickly and conveniently carry out transactions for a number of reasons. For example, a nightclub owner may purchase an ATM for placement in the nightclub that the nightclub owner operates to make increased profits at the bar of the nightclub as well as to make profits from the ATM. Availability of an ATM at the nightclub allows patrons of the nightclub to replenish their currency supplies if and when the patron runs out of currency. The ability to replenish currency supplies increasing the likelihood of the patron spending more currency at the nightclub. Even if the patron that replenishes his or her currency supply does not spend more currency at the nightclub, the nightclub owner can still receive profits associated with the transactional costs that the patron may pay in order to use the ATM. Financial institutions generally operate large networks of ATMs that allow customers of the financial institutions to have more freedom in performing financial transactions. Customers of the financial institution that provides such a large network of ATMs view the increased freedom as a benefit of doing business with a particular financial institution. The financial institutions view ATMs as another source of potential revenue.

ATM operators must effectively manage each ATM the ATM operator controls in order to carry out the reason for placing the ATM in a particular location. Generally, fulfillment of the reason for placing the ATM in a particular location requires that the ATM is operational for use by an ATM customer whenever the ATM customer would like to utilize the ATM to perform a transaction. An ATM that is operational is functioning correctly (i.e., no mechanical nor electrical breakdowns) and includes a sufficient amount of currency to process each transaction that is requested by an ATM customer. If an ATM is not operational, the ATM customer generally locates another ATM and uses that ATM to perform the transaction. ATMs are typically configured to allow ATM customers associated with the ATM operator as well as ATM customers that are not associated with the ATM operator (i.e., foreign ATM customers) to utilize the ATM. If the same ATM operator does not control the first non-operational ATM and the second operational ATM, then the ATM operator of the first ATM loses any revenue corresponding to that particular transaction. The ATM operator of the non-operational ATM may also lose revenue associated with future transactions if the ATM customer does not return to the first ATM because of a negative experience at that ATM.

Current ATM management techniques are fragmented, expensive to implement, and limited in functionality. Current ATM management techniques are often performed by a number of individuals associated with the ATM operator, performed by various service providers contacted by the ATM operator, or performed by any combination thereof. In addition, current ATM management techniques include ATM monitoring systems that only review status signals received from the ATM. Status signals may include an offline status signal, a low currency status signal, an out of currency status signal, a jam status signal, and the like. The status signals generally focus on problems that are occurring at the ATM, and are typically received by a monitoring application. In some cases, the ATM operator communicates with the monitoring application via a voice recognition unit (“VRU”) to determine what problems are occurring at the ATMs. Many ATM operators utilize a service provider to monitor the ATMs associated with the ATM operator primarily because conventional ATM monitoring applications are fairly expensive and are often not user-friendly. The ability of a party to directly monitor one or more ATMs (without accessing such information through a service provider) is therefore limited to large financial institutions having the ability to purchase a monitoring application for this purpose. For all other parties, the ability to directly monitor and manage ATMs is limited to those functions of the service provider's application that are made available to such parties by the service provider.

Accordingly, increasing demand has been placed by and upon ATM operators to effectively and efficiently monitor and manage the ATMs for which the operator is responsible. Also, there is increasing demand by owners of ATMs to be able to monitor and manage their ATMs, whether the owners are the ATM operators or whether another service provider is hired to operate the ATMs. However, conventional ATM monitoring and management products have done little to meet these demands. Conventional ATM monitoring and management products do not enable an ATM operator or owner to quickly gather significant amounts of information regarding the status and currency levels in an ATM (from a remote location or otherwise). Also, conventional monitoring and management products fail to ease the administrative burden of operating an ATM. This burden is due in large part to the manually-intensive and time consuming ATM management procedures typically followed by ATM operators and financial institutions. Such ATM management procedures include conventional currency management, ATM balancing and reconciliation, and deposit verification procedures.

### SUMMARY OF THE INVENTION

Effective management of an ATM includes management of a number of different factors. The factors can include currency amounts in the ATM, status signals received from the ATM, couriers that are contracted by the ATM operator to perform services related to the ATM, back office currency reconciliation for the ATM, deposit verification and handling for the ATM, general ledger reconciliation for the ATM, ATM profitability, ATM deployment programs, and still other functions that are related to the ATM and its operation.

In some preferred embodiments of the present invention, an ATM management application is used to provide an ATM operator with a comprehensive set of ATM management information. This ATM management information can enable the ATM operator to increase ATM profitability through improved ATM availability and expense reduction. The ATM management application can include any number of the following modules: a currency management module, a status inquiry module, a courier services module, an auto balance module, a deposit verification module, and a site analysis and profitability management module. The ATM management application can also include other modules that perform management of other functions related to an ATM.

In one embodiment, the invention provides a method of managing an ATM. The method includes providing a processor adapted to be coupled to an ATM, the ATM including a receptacle configured to retain a range of currency amounts between and including an empty currency amount and a full currency amount; receiving first data from the ATM, wherein the first data corresponds to a first amount of currency in the receptacle between the empty currency amount and the full currency amount; storing the first data in a memory associated with the processor; receiving a transaction request at the ATM; changing the first amount of currency in the receptacle to a second amount of currency in response to the transaction request, wherein the second amount of currency in the receptacle is between the empty currency amount and the full currency amount; receiving second data from the ATM, the second data corresponding to the second amount of currency in the receptacle; storing the second data in the memory associated with the processor; receiving a query for at least one of the first data and the second data; and outputting data corresponding to the at least one of the first data and the second data in response to the query.

In another embodiment the invention provides a method of a method of managing an ATM. The method includes receiving multiple transaction requests at the ATM; changing an amount of currency in the ATM in response to at least some of the multiple transaction requests; receiving data corresponding to a plurality of different currency amounts from the ATM over a period of time, wherein the plurality of different currency amounts are each greater than zero; receiving a query for an amount of currency in the ATM at a given time in the period of time; and outputting data representative of the amount of currency in the ATM at the given time, the amount of currency being one of the plurality of different currency amounts.

In another embodiment the invention provides a system for managing an ATM. The system includes a processor adapted to be coupled to the ATM for receiving data from the ATM, wherein the data corresponds to a plurality of different currency amounts in the ATM, the plurality of different currency amounts including a range of currency amounts between an empty currency amount and a full currency amount; a memory associated with the processor, wherein the processor is configured to store the data received from the ATM in the memory; and a user interface operable with the processor, the user interface operable to accept a query from a user for data corresponding to at least one of the plurality of different currency amounts and to output data corresponding to the at least one of the plurality of different currency amounts to the user.

In another embodiment the invention provides a method of managing an ATM. The method includes providing a processor configured to establish communication with at least one courier service and with at least one ATM; retrieving data corresponding to at least one courier service, wherein the data includes courier information and schedule information of the courier; sending from the ATM to the processor at least one of data corresponding to currency amounts in the ATM and status signals corresponding to ATM operation; updating the schedule information of the courier in response to at least one of the data received and the status signals received by the processor; and sending the updated schedule information from the processor to the at least one courier.

In another embodiment the invention provides a method of balancing an ATM. The method includes providing a processor adapted to be coupled to an ATM; sending data corresponding to at least one currency amount in the ATM from the ATM to the processor, wherein the at least one currency amount is calculated by the ATM; sending the data corresponding to the at least one currency amount in the ATM to a user interface for display to a user; displaying the data to the user via the user interface; counting at least one amount of currency retrieved from the ATM; comparing the data corresponding to the at least one currency amount calculated by the ATM to the at least one amount of currency retrieved from the ATM; and calculating a difference between the at least one currency amount calculated by the ATM and the at least one amount of currency retrieved from the ATM, wherein the difference is one of a negative amount, a positive amount, and zero.

In another embodiment the invention provides a method of determining profitability of an ATM. The method includes providing a processor adapted to be coupled to the ATM; sending from the ATM to the processor data representative of financial transactions performed by the ATM; storing the data representative of the financial transactions in a memory associated with the processor; receiving at the processor data representative of operating costs associated with operation of the ATM; calculating a cost associated with operating the ATM for a period of time, the cost based at least in part upon the data representative of the operating costs associated with operation of the ATM; calculating a revenue generated by the ATM for a period of time, the revenue based at least in part upon the data representative of the financial transactions; and outputting the profitability of the ATM, the profitability based upon the calculated cost and the calculated revenue.

As is apparent from the above description, it is an advantage of the invention to provide an improved method and apparatus for monitoring and/or managing ATMs. Other features and advantages of the present invention will become apparent by consideration of the detailed description and accompanying drawings.

### BRIEF DESCRIPTION OF THE DRAWINGS

In the drawings:

FIG. 1 is a block diagram of a representative ATM network;

FIG. 2 is a block diagram of a representative ATM network including a user interface used to access an ATM management application according to a preferred embodiment of the present invention;

FIG. 3 is a block diagram of an ATM management application according to a preferred embodiment of the present invention;

FIG. 4 is a block diagram of a currency management module of an ATM management application according to a preferred embodiment of the present invention;

FIG. 5 is a block diagram of a status inquiry module of an ATM management application according to a preferred embodiment of the present invention;

FIG. 6 is a block diagram of a courier services module of an ATM management application according to a preferred embodiment of the present invention;

FIG. 7 is a block diagram of an auto balance module of an ATM management application according to a preferred embodiment of the present invention;

FIG. 8 is a block diagram of a deposit verification module of an ATM management application according to a preferred embodiment of the present invention; and

FIG. 9 is a block diagram of a site analysis and profitability module of an ATM management application according to a preferred embodiment of the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

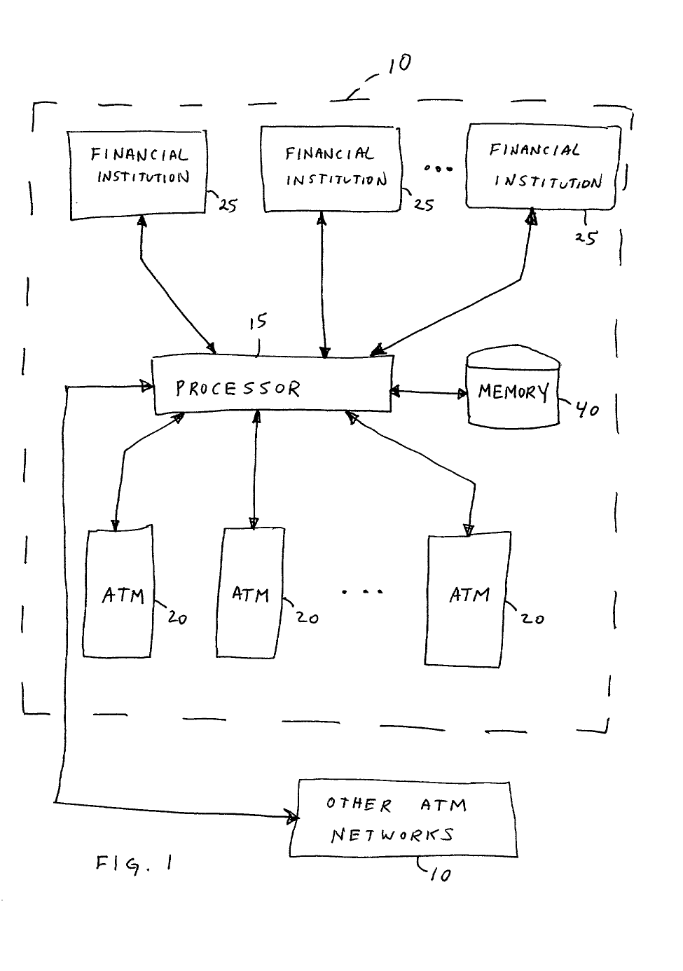

FIG. 1 illustrates a block diagram of a representative ATM network 10. The ATM network 10 can include a processor 15 that acts as a gateway through which a customer at an ATM can communicate with a financial institution associated with the ATM customer. The processor 15 is typically controlled and maintained by an ATM operator (e.g., a large financial institution) or a service provider that is contracted by any number of ATM operators. Large financial institutions typically control a sufficiently large number of ATMs that the costs associated with operating the processor 15 are justifiable. Other ATM operators may contract with a service provider that operates the processor 15 so that the costs associated with operating the processor 15 are distributed across a number of ATM operators. The ATM network 10 includes at least one ATM 20 and at least one financial institution 25. The ATM network 10 can be coupled to any number of similar ATM networks 10 as is well known in the art. ATM configurations are well known to those skilled in the art and are not therefore described further herein.

In some preferred embodiments of the present invention such as that shown in FIG. 1, the ATM network 10 includes a memory 40 that is coupled to the processor 15. In one embodiment, the memory 40 is used to store ATM management information received from ATMs 20. ATM management information can also be stored in other memory devices as desired.

Each ATM 20 is essentially a data terminal that allows an ATM customer to perform a transaction. The ATM customer is identified by data typically obtained from a card (e.g., ATM card, check card, debit card, credit card, and the like) that is read by a card reader on the ATM 20. However, other customer identification devices and methods exist and can instead be used, such as retinal or fingerprint scanning. The ATM customer can also enter a personal identification number (“PIN”) using a keypad on the ATM 20. In some cases such as for retinal or fingerprint scanning, a PIN is not required. The ATM customer is preferably allowed to use the ATM 20 if identified as an authorized user based on the data read from the card and the entered PIN.

A display screen on the ATM 20 preferably prompts the ATM customer through each step of the transaction process at the ATM 20. When the user has defined the transaction that is desired, the ATM 20 preferably communicates with the financial institution 25 associated with the ATM customer via the processor 15 for authorization of the desired transaction. The financial institution 25 associated with the ATM customer may or may not be included in the ATM network 10 of the ATM 20. If the financial institution 25 authorizes the transaction, the ATM 20 preferably receives an authorization signal and the transaction is processed (for example, currency is dispensed from a currency dispenser on the ATM 20). At the completion of the transaction process, the ATM customer may receive a receipt.

Although the ATM customer is normally only concerned with completing the desired transaction, the ATM operator is concerned with efficient management, operation, and monitoring of the ATM 20 for maximizing the profit thereof. The present invention provides an ATM management application 100 that addresses one or more of these concerns. In some embodiments, the ATM management application 100 provides the ATM operator with a comprehensive set of ATM management information that allows the ATM operator to efficiently fulfill the reason for placing the ATM 20 in the location. The ATM operator can use the ATM management information to increase ATM profitability through improved availability and expense reduction.

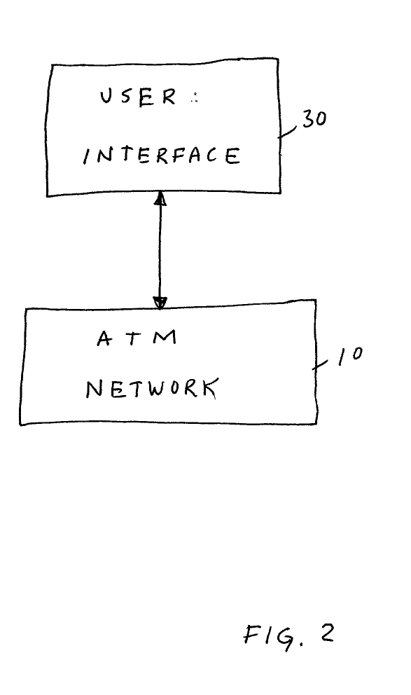

A user interface 30 (illustrated in FIG. 2) is coupled to the ATM network 10. As discussed below, the user interface 30 can reside within or outside of the ATM network 10. The interaction between the user interface 30 and the ATM management application 100 allows a user (e.g., an ATM operator) of the ATM management application 100 to receive ATM management information. In some preferred embodiments, ATM management information is received seamlessly from at least one ATM 20 and/or is received from a memory that stores ATM management information (e.g., the memory 40). ATM management information generated by the ATM 20 is preferably received by the processor 15 during the communication process between the ATM 20 and the processor 15. In one embodiment, the communication process is associated with processing a transaction at the ATM. In another embodiment, the communication process in not associated with processing a transaction, and is performed for purposes of ATM management information retrieval from the ATM 20 in transaction form or in batch form. ATM management information can also be received from sources other than ATMs 20 (e.g., ATM operator, databases of ATM management information, and the like).

A user can access the ATM management application 100 by using the user interface 30. The interaction between the user interface 30 and the ATM management application 100 is in accordance with techniques generally known in the software arts. The ATM management application 100 preferably resides on a computer (i.e., a processor and a memory associated with the processor). In one embodiment, the computer the ATM management application 100 resides in the processor 15 and/or the memory 40. In another embodiment, the computer in which the ATM management application resides is coupled to the processor 15 and/or the memory 40 to which the ATMs 20 are connected. The user interface 30 also preferably resides on a computer (not shown). In one embodiment, the computer on which the user interface 30 resides is the same computer on which the ATM management application 100 resides. In another embodiment, the computer on which the user interface 30 resides is coupled to the computer on which the ATM management application 100 resides.

The interaction between the user interface 30 and the ATM management application 100 is typically defined by how an owner of ATMs 20 controls the operation of those ATMs 20. The owner of ATMs 20 can act as the ATM operator. Alternatively, the owner of ATMs can contract with a service provider acting as the ATM operator for the owner. If the owner acts as the ATM operator, the owner may operate the processor 15 or the owner may contract with a service provider that operates the processor 15. What the owner does with respect to controlling operation of the ATMs 20 often depends upon the number of ATMs 20 controlled by the owner. If the owner controls a large enough number of ATMs 20, the owner may operate the processor 15 and control the operation of the ATM management application 100. Other owners may contract with a service provider that controls the operation of the ATM management application 100. The user of the ATM management application 100 preferably determines what ATM management information is received from the ATM management application 100 (as discussed below), but the entity that controls the operation of the ATM management application 100 preferably determines who the users are and what type of access the users have. In other embodiments, the ATM management application 100 is used by other entities including entities that operate other ATM networks 10 and entities that have ATM management information stored in a memory.

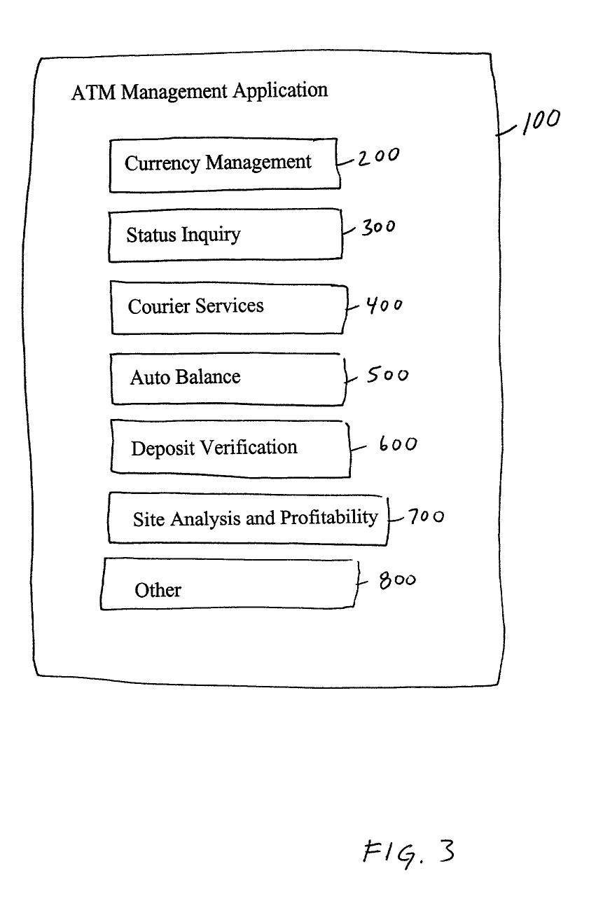

As illustrated in FIG. 3, one embodiment of the ATM management application 100 includes a currency management module 200, a status inquiry module 300, a courier services module 400, an auto balance module 500, a deposit verification module 600, and a site analysis and profitability management module 700. Other embodiments of the present invention can have any one or more of these modules. The ATM management application 100 can also include other modules 800 that perform management of other functions related to an ATM.

The currency management module 200 allows the user to selectively view ATM management information (hereinafter data) corresponding to at least one amount of currency in an ATM 20. In one embodiment, the user can choose to view data representative of a number of ATMs 20 at the same time (e.g., any number of ATMs 20 associated with a processor 15, a financial institution 25, a courier servicing the ATMs, a courier route to which the ATMs are assigned, a predefined view, and the like). The user can view data for all ATMs associated with the processor 15 or can be restricted to only view data for each of the ATMs 20 the user has access to. In many cases, the user only has access to data for ATMs 20 supported by a single processor 15 (i.e., ATMs 20 located on a single ATM network 10). However, in some embodiments, the user can have access to data for ATMs 20 supported by at least two processors 15 (i.e., ATMs 20 located on at least two different ATM networks 10). The degree of access the user has generally depends upon who the user is (e.g., an employee of a financial institution, an employee of a service provider, a network administrator, and the like).

An ATM 20 generally includes at least one receptacle or canister (not shown) as is well known to those skilled in the art. Each receptacle holds currency that is distributed to the ATM customer upon completion of a withdrawal transaction. Currency can include any item of value (e.g., paper money, coin money, stamps, movie tickets, vouchers, and the like). In one embodiment presented by way of example only, an ATM 20 includes a first receptacle that holds $100 bills, a second receptacle that holds $20 bills, a third receptacle that holds $10 bills, and a fourth receptacle that holds movie tickets valued at $5 each. The number and type of receptacles an ATM 20 includes is determined at least in part by the architecture of the ATM 20.

Before a financial transaction occurs, the ATM 20 includes a first amount of currency. The first amount of currency in the ATM 20 can fall anywhere within a range of currency amounts between an empty currency amount and a full currency amount. Similarly, the first amount of currency corresponds to first amounts of currency for each receptacle in the ATM. The first amounts of currency for each receptacle in the ATM can fall anywhere within a range of currency amounts between an empty currency amount and a full currency amount. The range of currency amounts for the ATM and for the individual receptacles therein can include the empty currency amount and the full currency amount. The full currency amount is generally the amount of currency in the ATM 20 (or cannister(s)) after a currency reset is performed. A currency reset is performed, for example, when a courier loads the ATM 20 with currency as instructed by an ATM operator. A currency reset can be performed by a courier taking out the receptacles in the ATM and replacing them with other receptacles holding a known amount of currency, by the courier determining how much money is in the receptacles in the ATM to which the courier adds money (bringing the amount of currency in the receptacles to a desired and known amount), and in still other manners. The manners in which a currency reset can be performed are well known to those skilled in the art and are not therefore described further herein. The full currency amount for an ATM and for an ATM cannister can be different each time a currency reset is performed (i.e., based on a review of currency amounts in the ATM 20, the ATM operator may determine that more or less currency should be loaded into the ATM 20 during a currency reset). The empty currency amounts of the ATM 20 and of an ATM receptacle preferably correspond to a state in which no currency remains in the ATM 20 and ATM receptacle, respectively. An ATM operator generally does not want an ATM 20 or an ATM receptacle therein to reach the empty currency amount condition.

An ATM 20 typically receives a number of financial transaction requests over a period of time. Not all requests require the ATM 20 to dispense currency. For example, the ATM customer may only desire to perform a financial transaction that transfers money between a checking account and a savings account, and/or the ATM customer may perform a financial transaction that deposits money into a savings account using the ATM 20. If a financial transaction is performed wherein a withdrawal is requested and approved, currency is dispensed to the ATM customer. Once currency has been dispensed, the ATM 20 includes a second amount of currency. The second amount of currency in the ATM 20 is preferably within the range of currency amounts, although the second amount is a value lesser than the first amount (i.e., assuming a courier has not added money to the ATM 20 between determination of the first amount and the second amount). Each time a financial transaction is requested by an ATM customer, the ATM 20 communicates with the processor which routes the communication to the appropriate financial institution 25 for approval. If the request is approved, the financial transaction is carried out by the ATM 20. In one embodiment, data is received by the processor 15 only during a communication process associated with processing a transaction (i.e., a passive system). In another embodiment, data is received by the processor 15 during a communication with the ATM that is not associated with processing a transaction (i.e., an active system). An example of the active system includes the processor 15 establishing communication with the ATM 20 (or vice versa), after which data is sent from the ATM 20 to the processor 15. The data can be sent to the processor 15 after the ATM 20 receives a request for the information from the processor 15. In another embodiment, a combination of the passive system and the active system is utilized. At least some of the data received by the processor 15 can be communicated to a financial institution 25. Additionally, at least some of the data received by the processor 15 can be saved in the memory 40.

In some preferred embodiments of the present invention, the data received by the processor 15 preferably corresponds to a number of different values that indicate what is occurring or has occurred in the ATM 20. In one embodiment, the data received includes data corresponding to the amount of currency in each receptacle of the ATM 20 and/or each ATM 20. ATMs 20 can be set up for either receptacle-level settlement or ATM-level settlement. When receptacle-level settlement is used, data representing the amount of currency in each of the receptacles is received by the processor 15. When ATM-level settlement is used, a single value of the total amount of currency in the ATM 20 is received by the processor 15. As an illustrative example, if an ATM 20 includes ATM-level settlement, the currency amount is indicated for the overall ATM 20 (e.g., ATM at 123 Main Street has $3275). However, if the same ATM 20 includes receptacle-level settlement, currency amounts are indicated for each receptacle included in the ATM 20 (e.g., ATM at 123 Main Street includes twenty $100 bills for a total of $2000, sixty $20 bills for a total of $1200, and fifteen movie tickets valued at $5 each for a total of $75). Both settlement methods result in a total value of $3275 in currency in the ATM 20, but the receptacle-level settlement data is more specific. Preferably, an ATM 20 used with the present invention incorporates receptacle-level settlement.

Data corresponding to the amount of currency in each receptacle is often more useful to the user of the currency management module 200. When the user can view data corresponding to the actual amount of currency in each receptacle, the user can determine if a courier needs to be instructed to perform a currency reset (which can include a currency add or a currency subtract). As discussed above, a currency reset resets the amount of currency in the ATM 20 to known levels determined by the ATM operator. A currency add may be utilized, for example, if an ATM operator determines that the amount of currency in all of the receptacles but one is adequate, and therefore, the currency in the one receptacle that is low needs to be supplemented. In one embodiment, the $10 bill receptacle may be empty while the $100 bill receptacle, the $20 bill receptacle, and the movie ticket receptacle are nearly full. Although the ATM 20 can still process requests for withdrawal transactions in $20 increments, the ATM 20 cannot process requests for withdrawal transactions of $10 or withdrawal transactions for $30, $50, $70, and the like (each requiring a $10 bill dispense). If the ATM operator believes that such a limitation may adversely affect ATM usage and operation, and that payment of a courier to perform a currency add is warranted, the courier is instructed accordingly. Similarly, if it is determined that the amount of currency in a receptacle is too high because the currency could be used elsewhere more effectively, and that payment of a courier to perform a currency subtract is warranted, the courier is instructed to remove currency from the receptacle that includes too much currency.

Preferably, the currency management module 200 allows the user to view data corresponding to the actual amount of currency in the ATM 20. Analysis of this data allows the user to make informed decisions about the amount of currency that should be kept in the ATM 20 and to therefore increase profitability of the ATM 20. Current ATM monitoring systems only review status signals that indicate when the currency in the ATM 20 is below a low currency threshold value and/or when the currency in the ATM 20 is out. Such limited information is normally not as useful to an ATM operator as the actual amount of currency in the ATM 20. For example, in one embodiment, a low currency status signal is received by the processor 15 only when the amount of currency in an ATM 20 falls below a low currency threshold set by an ATM manufacturer when the ATM 20 is produced or set on-site by a party installing or servicing the ATM 20. This lack of low currency warning flexibility can result in a low currency status signal received from a first ATM 20 that is in an exceptionally high traffic area at the same representative time a low currency status signal is received from a second ATM 20 that is in a low traffic area. The receipt of these two separate low currency status signals should mean something completely different to the ATM operator. However, without detailed information including the actual amount of currency in the ATM, the ATM operator may determine that it is necessary to instruct a courier to perform a currency reset instead of risk the ATM 20 becoming non-operational (e.g., not enough currency to process requested transactions, empty currency amount condition, and the like).

Due to the cost of courier services, an ATM operator normally desires to only instruct a courier to perform administrative transactions when necessary. A balance therefore needs to be made between the amount of “float” in the ATM 20 and the cost of courier services. The currency management module 200 and the other modules of the ATM management application 100 can assist the ATM operator in this regard. The user may determine that the amount of currency in the low traffic area may keep the ATM 20 operational until the next scheduled courier service, while the amount of currency in the high traffic area calls for immediate replenishment by a courier. The ability to know the actual amount of currency in the ATM 20, (whether or not coupled with data provided by other modules of the ATM management application 100) allows the ATM operator to increase profitability of the ATM 20.

Additionally, when an ATM operator does not have the ability to see current data corresponding to the amount of currency in the ATM 20 or in receptacles of the ATM, the ATM operator is less able to forecast how much currency should be kept in the ATM 20 to effectively balance the float versus courier service cost dilemma discussed above. For example, some ATM operators (e.g., large financial institutions) operate a large number of ATMs 20. If each ATM controlled by the ATM operator has a float amount that is too high, the compounding of these float amounts can result in exceptionally large amounts of currency sitting unused in the ATMs 20. Ideally, an ATM operator keeps enough currency in the ATM 20 so that ATM customers can complete each transaction they desire to complete. Additionally, the operator desires to keep the minimum amount of currency in the ATM 20 so the float amount of currency (i.e., the amount of currency sitting in the ATM 20 unused) is kept to a minimum. If currency is sitting the ATM 20 unused, the ATM operator is unable to use the currency for other purposes (e.g., interest income).

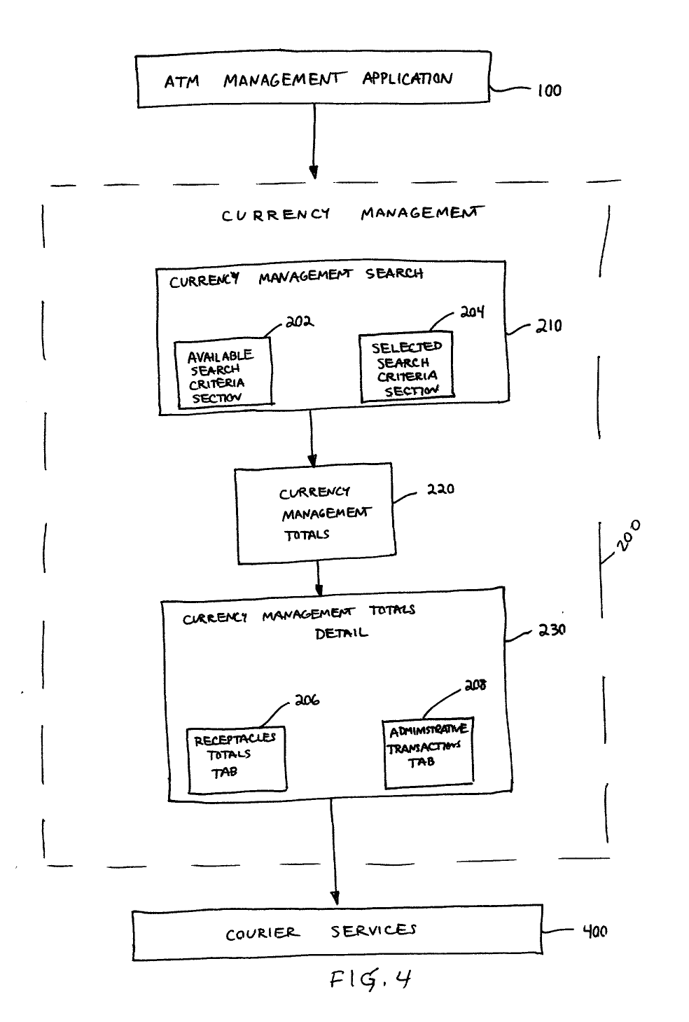

In the preferred embodiment of the present invention illustrated in the figures, to utilize the functions provided by the currency management module 200, the user first selects the currency management module 200 of the ATM management application 100. As illustrated in FIG. 4, a currency management search screen 210 is displayed that allows the user to define search criteria used to qualify which ATMs the user would like to evaluate. The currency management search screen 210 includes an available search criteria section 202 and a selected search criteria section 204.

Preferably, the user can specify the search criteria by using the available search criteria section 202. Specifically, the user can search for data using a number of different search criteria in the available search criteria section 202. In one embodiment, the user can select from a list of predefined views (i.e., lists of ATMs 20 that have been previously defined by the user), or the user can customize a search.

If the user decides to customize a search, the user can first select the entity to search by. Entities can include one or more processors 15, financial institutions 25, ATMs 20, couriers, courier routes, and the like. Once an entity is selected, a list box, table, or other listing containing all the members of the entity which the user has access to is preferably displayed. The user then selects a specific member from the list to search by. For example, if the user has initially selected ATMs as the entity to search by, identifiers for each of the ATMs 20 the user has access to are displayed as just described. The user can then select to view information about an ATM identified as 123 Main Street. As another example, if the user has initially selected financial institutions as the entity to search by, identifiers for each of the financial institutions 25 the user has access to are displayed. The user can then select to view information about all ATMs corresponding to a financial institution identified as Big Bank Corporation. In some embodiments, the entities can be named in any manner the user determines is useful for identification purposes. The currency management search screen 210 preferably also includes a look-up feature that allows the user to search for a particular entity by name, if desired.

In some embodiments of the present invention, the currency management search screen 210 permits a user to indicate that only ATMs 20 with low currency totals should be displayed. In one embodiment, low currency totals can be defined on an ATM-by-ATM basis (i.e., an ATM 20 located in a shopping center may be considered low on currency when the total currency level in the ATM 20 reaches $5000, while an ATM located in a lower traffic area may not be considered to be low on currency until the total currency amount in the ATM 20 reaches $2000). Therefore, the currency management section 210 of the currency management module 200 permits a user to define low currency totals for each ATM, if desired.

Once the user has specified the search criteria as described above, a search code representing that search criteria is moved to the selected search criteria section 204. Preferably, the user can then repeat the above steps and select additional search criteria. For example, the user may wish to search for all ATMs 20 included under two different courier routes. The user would first select the first courier route and move it to the selected search criteria section 204, and would then select the second courier route and move it to the selected search criteria section 204. After the user has finished all desired selecting search criteria, the user can instruct the currency management section 210 to perform a search by clicking on a search button located on the currency management search screen 210 or by operating any other user-operable control associated with the currency management search screen 210.

After a search (for ATMs meeting the selected search criteria) is ordered by a user, a currency management totals screen 220 is preferably displayed that includes data corresponding to the currency amounts for each ATM 20 located by the search defined by the user. Therefore, data for any number of ATMs 20 can be displayed. The data can include any or more of the following: a grand total amount for all types of currency in the ATM 20 (i.e., the total value of all currency in the ATM 20), a total amount of currency for each currency type in the ATM 20 (e.g., a total amount for dollars, a total amount for movie tickets, a total amount for stamps, and the like), a total amount for each receptacle (this amount can be the same as the amount of currency for each currency type if only a single receptacle is used for each currency type), an amount of currency dispensed from each receptacle, a currency code indicating the type of currency in the receptacle (e.g., 840=United States dollars, 760 =movie tickets), a sub-currency code indicating a denomination of the currency type (e.g., the currency code indicates United States dollars and the sub-currency code indicates $10 bills), a number of each type of currency units in each receptacle, and a low currency level code. The currency management totals screen 220 can also display information about the ATM 20 for which data is displayed. Such information can include such information as an ATM identification (“ID”), a location of the ATM (e.g., street address, city, state, zip code, and the like), a processor ID, a financial institution ID, a financial institution name, a date and a time indicating when the last transaction at the ATM 20 took place, and the like. If data for more than one ATM 20 is displayed using the currency management totals screen 220, then the information about the ATM 20 is preferably displayed for a selected ATM 20. If the user did not indicate (when defining the search) that only ATMs 20 with low currency levels should be displayed, some embodiments of the currency management totals screen 220 can permit the user to filter the ATMs 20 for which data is displayed by selecting a low currency level button or other user-operable control located on the currency management totals screen 220 or otherwise associated with the currency management totals screen 220.

In an alternative embodiment of the present invention, the currency management module 200 does not have a currency management search screen 210 as described above. Instead, the currency module 200 permits a user to select from a list of ATMs in order to display currency totals via the currency management totals screen 220. Alternatively, the user can directly specify one or more ATMs by ATM identifier in order to display currency totals for such ATMs via the currency management totals screen 220.

Although not required, the user can select to view data corresponding to a particular ATM on a currency management totals detail screen 230. In a preferred embodiment illustrated in FIG. 4, the currency management totals detail screen 230 includes a receptacle totals tab 206 and an administrative transactions tab 208. In different embodiments of the present invention, one or both of these tabs 208 can be displayed. The receptacle totals tab 206 preferably displays data similar to that discussed above in a format that is easier for the user to view. In one embodiment for example, a grid of data is displayed that includes data for each receptacle located in a separate column and summary totals data located in a separate part of the grid of data. The administrative transactions tab 208 preferably displays information related to administrative transactions (e.g., currency resets, currency additions, currency removals from the ATM, a history of transactions performed by the ATM over a day, month, or other period of time, and the like) that have occurred at the selected ATM 20. In one embodiment, the twenty most recent administrative transactions are displayed on the administrative transactions tab 208. Other data can also be displayed in various embodiments of the present invention, such as data including the type of administrative transaction, the date and time the administrative transaction occurred, the amount of currency in the ATM at the time of the administrative transaction (data similar to that discussed above with respect to the amount, type, and sub-type of currency in each receptacle), and courier data that indicates who performed the administrative transaction may be displayed.

In some embodiments, the currency management module 200 allows the user to print the displayed data and/or to export the displayed data to another application (such as a spreadsheet application or a database application). The ability to perform such functions allows the user to effectively utilize the data provided by the currency management module 200. The user can preferably also customize the display of data for optimum usage.

In one embodiment, the currency management module 200 also includes a direct link to the courier services module 400 discussed below. The link allows the user to provide instructions to the courier regarding how to proceed. In another embodiment, the currency management module 200 can automatically contact the courier based upon predefined decisions developed by the user (i.e., one or more messages are automatically sent to the courier upon the state of one or more ATMs reaching a predetermined condition). For example, when the currency management module detects that an ATM 20 has reached a low currency state, one or more messages corresponding to this state can be retrieved from a look-up table or can be generated from a decision engine and can thereafter be automatically sent to the courier (e.g., by e-mail, telephone, fax, and the like).

The status inquiry module 300 of the ATM management application 100 preferably allows a user to selectively view data corresponding to status signals received from an ATM 20. In one embodiment, the user can choose to view data representative of a number of ATMs 20 at the same time (e.g., all of the ATMs 20 to which the user has access). As discussed with respect to the currency management module 200, the access of the user may be limited.

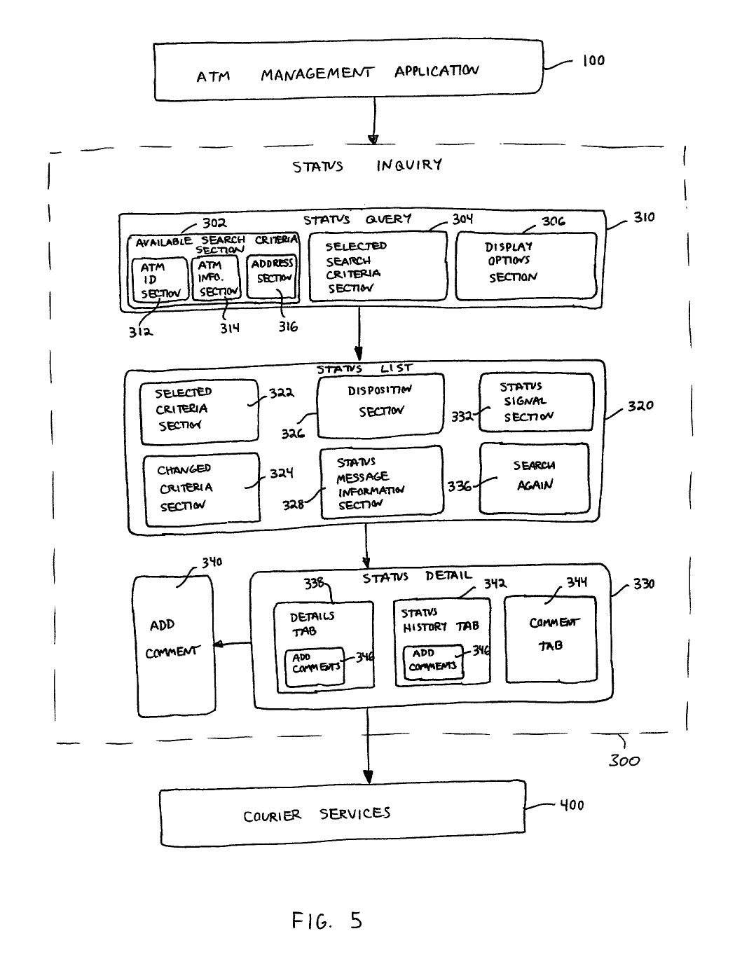

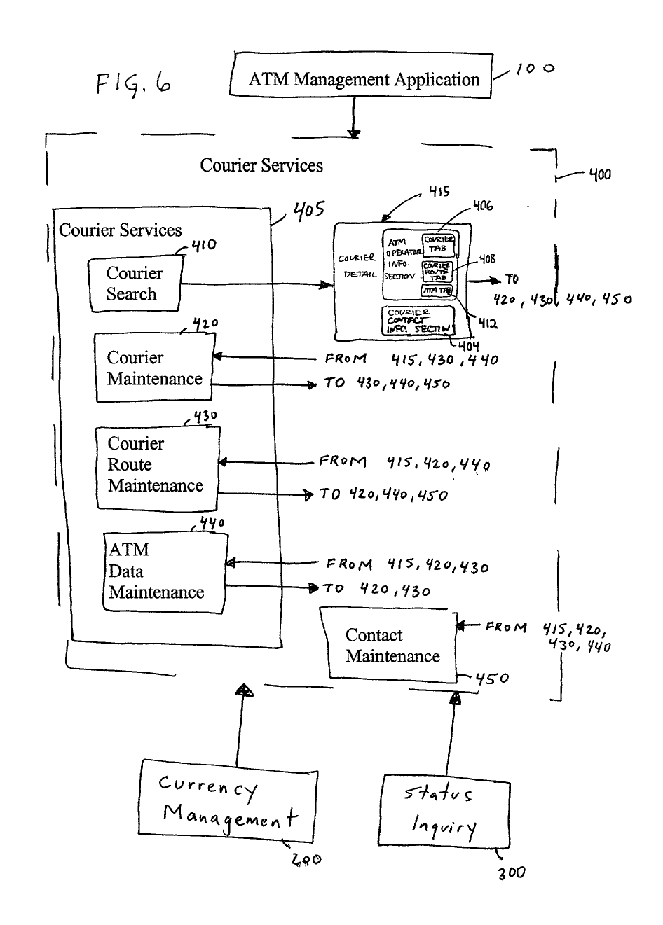

In the preferred embodiment of the present invention illustrated in the figures, to utilize the functions provided by the status inquiry module 300, a user first selects the status inquiry module 300 of the ATM management application 100. As illustrated in FIG. 5, a status query screen 310 can be displayed that allows the user to define search criteria used to qualify which ATMs 20 the user would like to evaluate for status signals. Alternatively, one or more ATMs can be selected by the user from a list provided by the status inquiry module 300 or can be directly identified by a user with ATM identifiers. In some preferred embodiments, the status query screen 310 is made up of an available search criteria section 302, a selected search criteria section 304, and a display options section 306. The available search criteria section 302 can include such search criteria as an ATM ID section 312, an ATM information section 314, and/or an address section 316. The available search criteria section 302 is preferably used to select the criteria the user wants to use to search for ATMs 20 that have generated status signals (whether such a search is limited, for example, by ATM identification, ATM information, and/or ATM address). The user can preferably search for data corresponding to status signals received from ATMs 20 using a number of different search criteria.

The user can preferably use the ATM ID section 312 to specify either a single ATM ID or all available ATMs 20 as the search criteria for ATMs 20 that have generated status signals. Preferably, the user can select all available ATMs 20 (i.e., each ATM 20 for which the user has access) by selecting a field on the status query screen 310, a field on the ATM ID section 312, or a field otherwise associated with the status query screen 310 or the ATM ID section 312. If the user selects all available ATMs 20 as the search criteria, then the other fields in the available search criteria section preferably become inactive because the currently defined search returns all possible results.

If the available search criteria section 302 has an ATM information section 314, the user can preferably use the ATM information section to specify information regarding ATMs in order to identify which ATMs are to be viewed. Examples of such information include a status code, an ATM state, a reporting level ID, a financial institution ID, a processor ID, and/or a vendor type, any one or more of which can be used as the search criteria to find ATMs 20 that have generated status signals. The status code can be an alert number of the status signal sent by the ATM 20 (i.e., a number assigned by the processor 15 which identifies the status signal, such as 0=test, 1=tracking, 3=general, 5=entity, 7=warning, 9=error). The ATM state preferably indicates the operating state of the ATM 20 (e.g., 1=up, 2=troubled, 3=down). The reporting level ID preferably indicates a merchant identification (i.e., the entity that is accepting financial transactions from the ATM). The financial institution ID preferably indicates the financial institution that operates the ATM 20. The processor ID preferably indicates the acquiring or issuing processor 15 associated with the ATM 20. The vendor type preferably indicates the make and/or model number of the ATM 20.

If the available search criteria section 302 has an address section 316, the user can preferably use the address section to specify a city, state, postal code, or other location information for search criteria to identify one or more ATMs that have generated status signals. By way of example, the city indicates the city in which the ATM 20 is located, the state indicates the United States Postal Service abbreviation for the state in which the ATM 20 is located, and the postal code indicates the United States Postal Service postal code associated with the location of the ATM 20.

The status inquiry module 300 preferably includes functionality similar to the currency management module 200 in that the user can preferably perform searches for particular entities to enter into the fields of the status query screen 310. For example, the user may search for a particular financial institution ID if the user is unsure of the exact financial institution ID.

The ability to define a large array of search criteria to search for status signals generated by ATMs allows a user to perform different functions in searching for status signals received from ATMs 20. For example, in some embodiments of the status inquiry module 300 the user can search for all available ATMs 20 to see if any ATMs 20 are currently not operating correctly. In these and other embodiments, the user can search for the vendor type to determine if a specific make and model of ATM 20 has a higher failure rate than other makes and models. The user may instead search for an ATM state to determine which ATMs 20 need service soon and which ATMs 20 need service immediately.

Once the user has defined search criteria to identify which ATMs the user wishes to view, a search code representing that search criteria is preferably moved to the selected search criteria section 304. In some embodiments, the user can then repeat the above steps and select additional search criteria. After the user has finished selecting the desired search criteria, some embodiments of the present invention enable the user to define display options for the search results generated. For example, the user can use the display options section 306 to indicate the maximum number of status signals that should be retrieved when a search is performed. In one embodiment, the maximum number of status signals that can be retrieved at one time is forty-five. The user can also or instead use the display options section to remove certain types of status signals which would otherwise be generated by a search. Preferably, the most recent status signals are displayed as results of a search. For example, if a user specifies a maximum of forty-five status signals to be displayed and only twenty-five status signals are located in the current search, up to twenty other status signals displayed from previously performed searches may be displayed with the results of the current search. However, a user-manipulatable control is preferably provided to enable the user to clear existing records from earlier searches in order to view only the results pertaining to the most current search. Once all search criteria are selected and the display options are defined, a search is preferably performed. Following selection of which status signals are desired to be viewed (whether by directly identifying one or more ATMs 20 or by identifying the status signals to view by a search process as described above), a status list screen 320 is preferably displayed which includes data corresponding to the status signals located by the search defined by the user. The status list screen 320 preferably displays the most recent status signals received. The status list screen 320 can present the search results in any format desired. In the preferred embodiment illustrated in the figures by way of example, the status list screen 320 includes a selected criteria section 322, a changed selection criteria section 324, a disposition section 326, a status signal information section 328, and a status signal section 332. Any or all of these sections can be employed in other embodiments of the present invention.

The selected criteria section 322 preferably indicates the number of status signals that were retrieved during the search defined by the user which are currently displayed in the status signal section 332. The selected criteria section 322 also preferably allows the user to retrieve status signals that were found in the earlier search but which are not currently displayed in the status signal section 332 by clicking on a “retrieve more” button 334 or other user control preferably located in the selected criteria section 322 or otherwise associated with the selected criteria section 322 or the status list screen 320. If the user selects the retrieve more button 334, the status inquiry module 200 preferably retrieves the next set of status signals which were found in the earlier search and adds them to the existing list of status signals displayed in the status signal section 332. When there are no more status signals to be retrieved, the retrieve more button 334 preferably becomes inactive.

In some preferred embodiments of the status inquiry module 300, the selected criteria section 322 also allows the user to conduct an updated search if the original search did not produce the expected results. If the user selects a search again button 336 (or other such user control located in the selected criteria section 322 or otherwise associated with the selected criteria section 322 or the status list screen 320), an updated search for status signals is preferably initiated, including any changes to the search indicated in the changed selection criteria section 324.

The changed selection criteria section 324 allows the user to change search criteria as just described without going back to the status query screen 310. In various embodiments, the user can alter any one or more of the ATM ID, the status code, the ATM state, the reporting level ID, the processor ID, the institution ID and the vendor type. When all desired changes are made, the user can preferably generate another search by the search again button 336.

The disposition section 326 preferably allows the user to filter the type of status signals that are displayed in the status signal section 332. In one embodiment, the filer filters based upon the ATM state. For example, if the user would only like to see the ATMs 20 that are down, a certain state is preferably selected. If the user would only like to see the ATMs 20 that are troubled, another state is preferably selected. If the user would only like to see the ATMs 20 that are up, yet another state is preferably selected. If the user would like to see any combination of the ATMs in the up, troubled, and down states, the states can preferably be selected accordingly.

The status signal section 332 preferably displays status signal data for each status signal displayed in the status list screen 320. The status signal data can include, for example, an ATM ID, an alert number, an ATM state, status text (i.e., text that may be displayed to the network operator), and the like.

The status signal information section 328 can include data corresponding to the status signal that is currently selected in the status signal section 332. In various embodiments of the status inquiry module 300, the status signal information section 328 can display status signal data including the date the status signal was received, the ATM ID of the ATM 20 that generated the status signal, the street address of the ATM 20, the state of the ATM 20, the status signal (for example, the ATM 20 is up, down, or troubled), the time the status signal was received, the ATM operator, the city in which the ATM 20 is located, the postal code of the ATM 20, the ATM type, the processor ID of the processor 15 associated with the ATM 20, and/or the financial institution ID of the financial institution 25 associated with the ATM 20. Still other information regarding a status signal can be displayed, if desired.

In some embodiments of the status inquiry module 310, the user has the ability to select and view data corresponding to a particular status signal on a status detail screen 330. The user preferably selects one of the status signals in the status signal section 332 of the status list screen 320 (and in some embodiments, executes a command via a user control on or associated with the status list screen 320). The status detail screen 330 is preferably then displayed with data about a single status signal that was selected on the status list screen 320. The status detail screen 330 can present details regarding a selected status signal in any desired format and in order to display any desired status signal details.

In the illustrated preferred embodiment of the present invention for example, the status detail screen 330 includes a details tab 338, a status history tab 342, and a comments tab 344. Various embodiments of the status detail screen 330 can include any or all of these tabs 338, 342, 344. The details tab 338 preferably displays data similar to that discussed above, and can also display a severity code (preferably set by the processor 15 and indicating the severity level of the status signal received from the ATM 20). In one embodiment, severity codes are mapped for use in automatically dispatching and notifying a courier to perform services on a particular ATM 25. This dispatching and notification process can occur automatically based upon predefined decisions developed by the user and located in a look-up table and/or implemented into a decision engine. In some embodiments of the status inquiry module 310, the details tab 338 can also displays any free-form comments that have been added (such as by the processor or another user) and relate to the status signal/or to the ATM 20. The status history tab 342 preferably displays historical status signal data. In one embodiment for example, the status history tab 342 displays status signal data for a prior period of time, such as for the last thirty days. In some embodiments of the present invention, the user can search for additional status signals generated by the ATM 20 that generated the displayed status signal using search criteria. For example, the search criteria can be defined by completing starting date and starting time fields and ending date and ending time fields within which a search for status signals generated by the ATM 20 can be made.

The comments tab 344 preferably displays comments that have been added for the displayed status signal and the ATM 20 that generated the displayed status signal. Preferably, comments are displayed with the most recent comment displayed first. Comments can be recorded in memory as part of historical status signal data and can preferably be viewed on the status history tab 342 of the status detail screen 330. In some highly preferred embodiments of the present invention, the user can preferably add free-form comments for the displayed status signal and for the ATM 20 that generated the displayed status signal. For example, the user can adds comments by selecting an add comments button 346 or other user control located on or otherwise associated with the details tab 338, the status history tab 342, the status detail screen 330, and/or other screens of the status inquiry module 300. Alternatively or in addition, an add comments tab 344 can be opened to access a comments screen. Preferably, the user can add an alphanumeric message to describe the status signal and/or the associated ATM 20. Comments can be useful in managing ATMs 20 in that the user can track past observances of the ATM 20 that generated the currently displayed status signal. For example, if the user determines that a particular ATM 20 consistently experiences a particular problem, the user can contact the courier to perform service on the ATM 20 so that the ATM 20 remains operational.

In one embodiment, the status inquiry module 300 includes a direct link to the courier services module 400 (discussed below). The link allows the user to instruct a courier regarding how to proceed. In another embodiment, the status inquiry module 300 can automatically contact the courier (such as by e-mail, fax, telephone, or in other manners) based upon predefined decisions developed by the user and located in a look-up table and/or implemented into a decision engine.

The courier services module 400 allows a user to manage couriers the ATM operator utilizes to perform administrative transactions at the ATMs 20 associated with the ATM operator. Courier services can define a large part of the expenses associated with operating an ATM 20. Effective management of courier services can reduce the overall costs associated with operating an ATM 20 and can therefore increase profitability of an ATM 20. The courier services module 400 preferably allows the ATM operator to more effectively manage one or more aspects of the interaction between the ATM operator and the couriers with which the ATM operator contract.

In the preferred embodiment of the present invention illustrated in the figures, to utilize the functions provided by the courier services module 400, the user preferably first selects the courier services module 400 of the ATM management application 100. As illustrated in FIG. 6, a courier services screen 405 can be displayed that preferably allows the user to access one or more portions of the courier services module 400, any one or more of which can be employed in various embodiments of the courier services module 400. In the illustrated preferred embodiment however, the courier services module 400 includes a courier search screen 410, a courier maintenance screen 420, a courier route maintenance screen 430, and an ATM data maintenance screen 440. Each screen accessible through the courier services screen 405 preferably allows the user to perform functions related to managing courier services.

The user can utilize the courier search screen 410 to determine what courier currently performs administrative transactions for a specific ATM 20, financial institution 25, and the like. In some embodiments, a number of couriers may perform administrative transactions for a specific ATM 20, financial institution 25, and the like. To identify couriers performing such transactions, the user first preferably specifies search criteria by using the courier search screen 410. The user can search for a courier based upon a number of different types of information. For example, the user can perform a search for couriers based upon ATM ID, a financial institution ID, a processor ID, or any other applicable search criteria. As discussed above with reference to the currency management module 200, in some embodiments the user may only search for data the user has access to. Once the user has defined the search criteria, a search is performed.

A courier detail screen 415 can be displayed as a result of the courier search described above. The courier detail screen 415 includes data corresponding to the couriers found in the search defined by the user. For example, the courier detail screen 415 can present information relating to couriers found in a search for all couriers servicing an ATM operator or for all couriers servicing an ATM. In this example, the courier detail screen 415 can include an ATM operator information section 402 (in which is displayed details regarding courier(s) servicing an ATM or ATM provider for which a search has been performed) and a courier contact information section 404. The ATM operator information section can display a variety of courier information in a number of different manners. In the illustrated preferred embodiment of FIG. 6 for example, the ATM operator information section includes a courier tab 406, a courier route tab 408, and an ATM tab 412. Any one or all of these tabs can be included in the courier detail screen 415 in other embodiments of the present invention. The ATM operator information section 402 preferably displays the selected tab 406, 408, 412 along with a summary of data presented under the selected tab 406, 408, 412. A summary of data in the courier detail screen 415 preferably changes to represent the row of data currently selected in a grid of data in each tab 406, 408, 412.

The courier tab 406 preferably displays detailed courier data. Contact information for the currently selected courier is preferably displayed in the courier contact information section 404 of the courier detail screen 415. The courier tab 406 can include a grid of data that displays such information as a courier name, a courier description (i.e., a user defined description of the courier), a financial institution ID, a user ID, a last date updated field, a last time updated field, and the like.

The courier route tab 408 preferably displays detailed courier route data. Contact information for the currently selected courier and/or courier route is preferably displayed in the courier contact information section 404 of the courier detail screen 415. The courier information section 404 can display route-specific contact information or can include only courier-wide contact information. The courier route tab 408 preferably includes a grid of data that displays such information as a courier route ID, a courier route description, a contact ID, an institution ID, a user ID, a last date updated field, a last time updated field, and the like. The courier route tab 408 also preferably allows the user to show all routes for a selected institution by selecting a check-off field preferably associated with the courier route tab 408.

The ATM tab 412 preferably displays detailed ATM data. Contact information for the currently selected courier is preferably displayed in the courier contact information section 404 of the courier detail screen 415. The courier contact information section 404 can display courier contact information that is courier specific, courier route specific, or even courier route and ATM specific as desired. The ATM tab 412 preferably includes a grid of data that displays information regarding the ATMs which are serviced by the courier. Such information can include any or all of the following data: ATM IDs, ATM status (e.g., 0=unknown, 1=up, 2=troubled, 3=down, and the like), financial institution IDs, addresses of the ATMs 20, cities, states, or postal codes in which the ATMs 20 are located, cutoff indicators (i.e., indicators regarding whether a cutoff will be generated in the absence of a cutoff record logged by an online system), cutoff starts (i.e., times entered that are used to create a time span during which a check is made for the existence of a logged cutoff record; if a logged cutoff record exists between this time and the cutoff time, then no cutoff record is generated, however, if no logged cutoff is found in this time span, a cutoff record is generated), cutoff times (i.e., cutoff timestamps assigned to the generated cutoff record), and ATM vendor models such as model numbers and names of the ATMs 20. In some embodiments, the ATM tab 412 also allows the user to show all ATMs 20 for a selected courier by selecting a check-off field.

Similar to the functions discussed above with respect to the grids of data in the currency management module 200, in some embodiments the user can preferably print, export, and customize the grids of data included in the courier tab 406, the courier route tab 408, and the ATM tab 412.

The user can preferably access the courier maintenance screen 420, the courier route maintenance screen 430, the ATM data maintenance screen 440, and a contact screen 450 (all described below) from the courier detail screen 415.

The user can utilize the courier maintenance screen 420 to perform at least one of the following functions: to read, add, update, and/or delete courier data. The courier data displayed on the courier maintenance screen 420 can include a courier name that identifies the courier that services ATMs 20 for an ATM operator, a courier description (i.e., a user-defined description of the courier), a financial institution ID of the financial institution or ATM operator that contracted with the courier to have courier services performed, a courier contact name, a method of contacting the courier contact (e.g., phone, fax, email, and the like), and contact information for the courier contact (e.g., phone number, fax number, email address, and the like). Still other information relating to the courier can be included in the courier data displayed on the courier maintenance screen 420. The amount of courier data that is initially displayed in the fields of the courier maintenance screen 420 can also depend upon how the user accesses the courier maintenance screen 420. For example, certain data may be displayed when the courier maintenance screen 420 is accessed directly rather than through another courier services module screen.

In some preferred embodiments, if a user accesses the courier maintenance screen 420 by linking from another screen (e.g., 415, 430, 440) to perform maintenance on the profile of a particular courier, then all fields include courier data. The user can preferably delete the courier profile by operate a delete button or other user control preferably on or associated with the courier maintenance screen. The user may delete a courier profile, for example, if the courier is no longer used to provide services. The user can preferably update the courier profile by changing at least one of the fields of courier data. In some embodiments, the user can utilize list boxes associated with each of the fields to select courier data to update the field. Preferably, the user can also input new courier data by inputting an identifier associated with the representative field to update the field. Once all courier data in the courier profile is correct, the user can operate an update button or other user control preferably on or associated with the courier maintenance screen 420. “Updated by” and updated timestamp fields displayed on the courier maintenance screen 420 can be used to indicate the user that made the change and when the update was made (e.g., date and time).

If the user wishes to add a new courier profile, the user preferably can perform steps similar to the update method discussed above or can start from a blank courier profile to enter courier data in all of the fields. The user can then operate an add button or other user control preferably on or associated with the courier maintenance screen 420 to add the new courier profile. The user may wish to establish a new courier profile if the ATM operator determines a different courier service may provide other or better service (e.g., less expensive and/or more timely) than a courier service currently being used. Such a determination can be made using the data available from the courier services module 400.

As mentioned above the user can preferably also utilize the courier maintenance screen 420 to retrieve a courier profile for review. The user may desire to review a courier profile if the user needs information regarding a particular courier. To view a courier profile in the illustrated preferred embodiment for example, the user preferably selects a financial institution ID and/or a courier name and then selects a read button located on or otherwise associated with the courier maintenance screen 420. The remaining courier data is then filled into the fields in the courier maintenance screen 420. In some preferred embodiments of the present invention, the user can also access the courier contact screen 450 from the courier maintenance screen 420.

The user can preferably utilize the courier route maintenance screen 430 to read, add, update, and/or delete courier route data in a manner similar to that discussed above with respect to the courier maintenance screen 420. Courier route data may include a financial institution ID (i.e., the financial institution or ATM operator for which the courier is performing services), a courier name (i.e., the courier that is performing the services), a courier route (e.g., route ten of the twenty routes the courier performs), a route description (e.g., southeast downtown route), and information regarding when the route is performed.

In some embodiments, information regarding when the route is to be performed is indicated by a number of fields. For example, a frequency type field indicates when the courier is scheduled to service a particular ATM 20 (e.g., a specific date or day, every day, on demand, weekly, and the like). Preferably, if a specific date is chosen as the frequency type, the user must select a frequency date. Also preferably, if a weekly schedule is chosen as the frequency type or if a day of the week is chosen as the frequency type, the user must select a frequency day. A frequency date field can be used which indicates the date of the month (e.g., the sixteenth day of the month) when the route is scheduled to be performed. Also, a frequency week field can be used which indicates a week of the month (e.g., first week of the month) on which the route is scheduled to be performed. A frequency day field can be used which indicates a day of the week (e.g., Tuesday) on which the route is scheduled to be performed. In some preferred embodiments, the user can define the data corresponding to when a route is to be performed by using a combination of the above (for example, the route is to be performed on the third day of each month in addition to every Tuesday). Such a definition can be used if on the fourth day of each month the ATMs 20 included on the route are used extensively (e.g., a large gathering takes place near the ATMs 20 that day each month). Still other manners of scheduling a courier route can be employed as desired, such as by selecting a number of exact dates upon which the courier is to service the subject ATM 20.

When a user wishes to read courier data in the illustrated preferred embodiment of FIG. 6 (for example), the financial institution ID, the courier name, and the courier route are preferably entered by selecting from list boxes or similar user controls for these fields and/or by inputting the courier route data using an input device (e.g., a keyboard, not shown). The user may search for data to enter in a particular field, if needed. The search capability is preferably available throughout the ATM management application 100. Once the user has entered the four fields, the user preferably operates a read button or other user-operable control located on or otherwise preferably associated with the courier route maintenance screen 430, thereby filling in the remaining courier data fields. In other embodiments of the present invention, courier data can be read by entering partial information into a blank courier search, courier maintenance, or courier route maintenance screen 410, 420, 430, whereby the remaining fields can be filled with data when a matching courier has been identified.

Once the user has had an opportunity to review the courier data, the user may wish to update the courier data. The user can change a field by selecting a different identifier from the list box associated with the field and/or by inputting an identifier using an input device. Once all changes are made, an update button or other user-operable control located on or otherwise associated with the courier route maintenance screen 430 can be selected. In some embodiments, once the courier data is updated, update timestamp and “updated by” fields are displayed. The update timestamp indicates when the update was made (e.g., date and time) and the “updated by” field displays a user ID which indicates the user that made the update.

Preferably, a user can add new courier routes by starting with a blank courier route maintenance screen 430 and by filling in each field to represent the courier data associated with the new route. An add button or other user-operable control located on or otherwise associated with the courier route maintenance screen 430 can then be selected by the user. Similarly, the user can preferably delete a courier route by displaying the courier data for the route and then selecting a delete button or other user-operable control located on or otherwise associated with the courier route maintenance screen 430.

The user can preferably utilize the ATM data maintenance screen 440 to assign and/or reassign an existing ATM 20 to a courier and a courier route. Once ATMs 20 are assigned, the corresponding ATM ID is preferably included in the representative courier data and courier route data. The ATM data maintenance screen 440 can display several fields of data that are relevant to an ATM and its service by a courier and courier route. The information in such fields can include, for example, an ATM ID, a financial institution ID, a courier name, a courier route, and the like. In some preferred embodiments, the user selects the ATM ID for the ATM 20 the user wishes to assign and/or reassign. The corresponding financial institution ID is then preferably displayed. The user can then select a courier name and a courier route from the list box associated with each of the representative fields. Once the user has defined the courier and the courier route, an update button or other user-operable control located on or otherwise associated with the ATM data maintenance screen 440 can be selected. An “updated by” field can be included to indicate the user that made the most recent assignment and/or reassignment. Also, an update timestamp can be included to indicate when the update occurred (e.g., date and time). In some preferred embodiments, the user can access the courier maintenance screen 420 and/or the courier route maintenance screen 430 from the ATM data maintenance screen 440.

Each courier preferably has a schedule that includes data corresponding to each of the routes a courier performs for an ATM operator, along with the ATMs 20 that are serviced on each of the routes. The schedule may include courier data, courier route data, and ATM data. In some preferred embodiments of the present invention, the courier maintenance screen 420, the courier route maintenance screen 430, and the ATM data maintenance screen 440 can all be utilized to maintain the schedule for a particular courier.

The contact maintenance screen 450 preferably allows the user to read, add, update, and/or delete contact data for a courier. In one embodiment, the contact maintenance screen 450 is a general-purpose screen that allows the user to maintain contact data for couriers, courier routes, and/or individual ATMs 20. The contact maintenance screen 450 can display a variety of contact information, including without limitation a contact type (e.g., all, courier, courier route), a user ID (i.e., last user to enter contact data for the indicated contact), a processor ID (i.e., the processor associated with the contact), a financial institution ID (i.e., the financial institution associated with the contact), a courier name, a courier route, a courier contact name, a method of contacting the courier contact (e.g., phone, fax, email, and the like), contact information for the courier contact (e.g., phone number, fax number, email address, and the like), and a courier address (e.g., a first address line, a second address line, a third address line, a fourth address line, and the like). Preferably, the user can read, add, update, and/or delete contact data in a manner similar to those discussed above with respect to the screens accessible from the courier services screen 405.

The auto balance module 500 assists a user in reconciling a balance sheet for an ATM 20 and in performing other functions associated with the reconciliation process. Generally, an ATM 20 is reconciled for a period of time known as a cutoff period. In one embodiment, a cutoff period is the period of time from a first currency reset to the next currency reset. In other embodiments, the cutoff period represents the period of time from a start time of the cutoff period to an end time of the cutoff period. The start time and/or the end time may or may not represent the occurrence of an administrative transaction (such as the servicing of the ATM by a courier). The ATM operator typically determines when reconciliation of the ATM 20 should take place. Some ATM operators reconcile ATMs 20 at the end of each business day. Other ATM operators reconcile ATMs 20 less frequently or more frequently. The frequency at which an ATM operator performs reconciliation can depend upon a number of factors, including the volume of transactions that occur at the ATM 20.

The reconciliation process normally includes performing a manual count of the currency retrieved from the ATM 20 and comparing the totals of the manual count against totals obtained from the ATM 20. The totals obtained from the ATM 20 are typically calculated using a journal of the transactions that occurred at the ATM 20. When a courier performs a currency reset, the courier normally removes the currency from the ATM 20 along with a journal produced by the ATM 20 (such as a paper version of the journal that is printed using a printer in the ATM 20). The retrieved currency and journal are then delivered to the “back office” of an ATM operator (e.g., a financial institution) for processing.

Staff at the back office typically review the journal to determine how much currency should be in the ATM 20 based upon data recorded in the ATM's journal. The staff may need to perform accounting-type functions on the journal to determine the totals. The staff also perform a manual count of the currency retrieved from the ATM 20 to determine if the totals for the manual count match the totals obtained from the ATM's journal. If an out-of-balance condition exists, an investigation is performed into the reason for the discrepancy. If the totals match, the balance sheet is considered to be reconciled.

Reconciliation is generally a manual and time-consuming process. The staff of the ATM operator that perform the reconciliation process generally experience a high turnover rate, thereby requiring the ATM operator to constantly train new staff. The manual aspects of the reconciliation process, coupled with a lack of discipline by the staff can result in audit issues, write-offs, and high exception penalties for the ATM operator. The auto balance module 500 of the present invention preferably provides the user with a more automated system that effectively manages reconciliation of an ATM. The auto balance module 500 can reduce the amount of training needed to accomplish reconciliation, can provide the user with the ability to view audit records and administrative transactions (e.g., currency adds, currency subtracts, and currency resets) that have been performed at the ATM, and can assist the user in performing other functions, such as exception processing of possible exception transactions that may have caused an out-of-balance condition, captured card services including the ability to track and update information and actions taken on cards captured by the ATM 20, and the like.

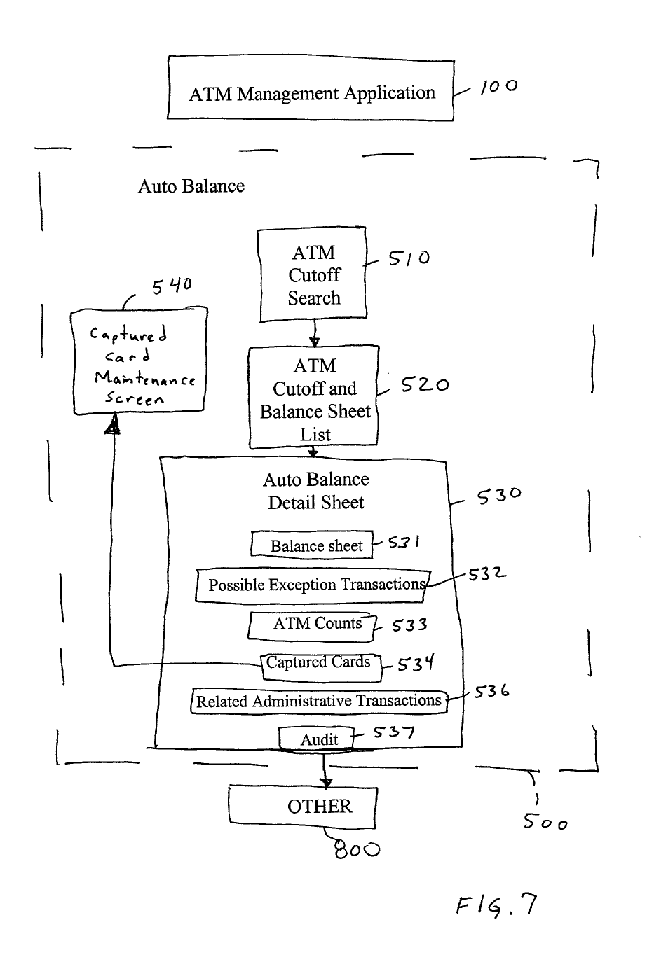

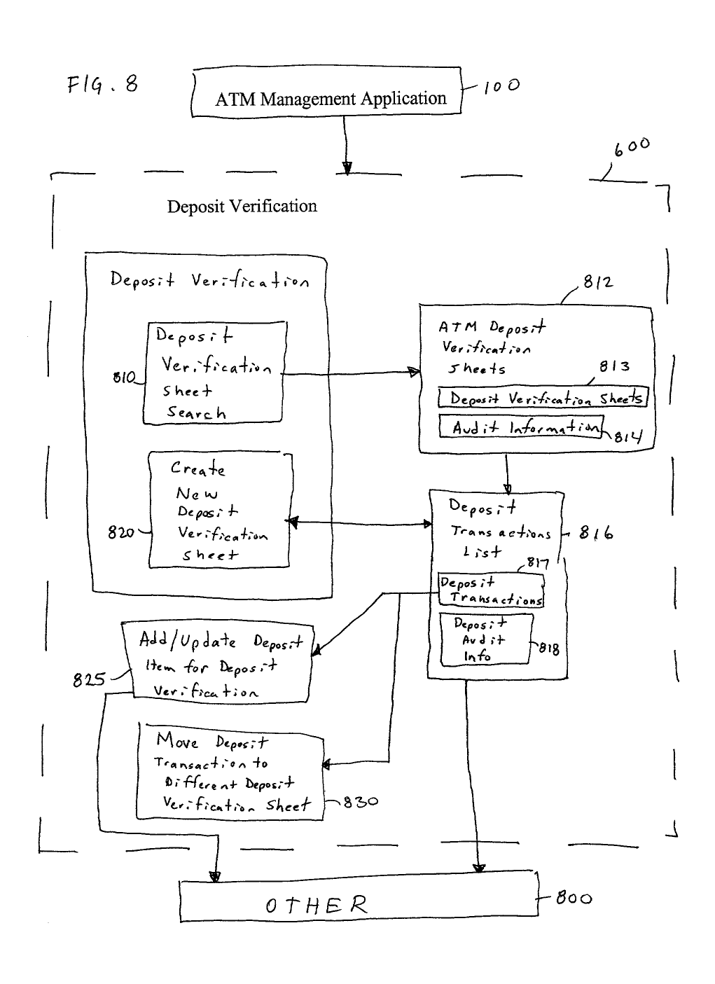

In some preferred embodiments of the present invention, to utilize the functions provided by the auto balance module 500, the user preferably first selects the auto balance module 500 of the ATM management application 100. As illustrated in FIG. 7, an ATM cutoff search screen 510 can be displayed that allows the user to define search criteria, such as a specific ATM 20 and a period of time used to qualify a search for cutoff periods for the specific ATM 20 and for any balance sheets that exist for the retrieved cutoff periods. The user can search for balance sheets corresponding to a cutoff period for a specific ATM 20 so that the user can perform reconciliation of the ATM 20 during that period. In the illustrated preferred embodiment of FIG. 7, The ATM cutoff search screen 510 includes a primary search section, a date and time options section, and a display options section.

The primary search section allows the user to select a specific ATM 20. The user can select the specific ATM 20 in a number of different manners, such as by entering an ATM ID in to a field in the primary search section or by selecting an ATM ID from a box list associated with the field. Preferably, the user can perform a search for a particular ATM ID if needed. The ATM ID is a value that uniquely identifies the ATM 20 for which a balance sheet needs to be reconciled. The ATM ID can represent a single ATM 20 or a group of ATMs 20.

The date and time options section allows the user to define a period of time that is used to search for cutoff periods and balance sheets associated with those cutoff periods. Preferably, the user enters a start date, a start time, an end date, and an end time in which to search for cutoff periods and associated balance sheets. The user can also or instead specify a period of time based upon a number of days previous to an end date and end time. If the user chooses this option, the user preferably fills a number of days into a representative field. The start date and the start time are then preferably automatically generated based upon the number of days entered by the user and the currently displayed end date and end time. In one embodiment, the end date and the end time are automatically defaulted to the current date and time. In another embodiment, the user can set the end date and the end time to the current date and time. Preferably, the user can also set the end date and end time to the start date and start time if the search criteria from the last search is still displayed in the representative field boxes. This option allows the user to search for the period of time that is subsequent to the period of time for which the last search was qualified to search without having to reenter data. In some embodiments, the user can also select to display a twenty-four-hour period for a specific date. The start date and start time are automatically generated based upon the currently displayed end date and end time when this option is selected. The user can use this option when the user desires to perform a search for a cutoff period that occurred within a twenty-four-hour period (e.g., a cutoff period of a particular business day). When the user selects this option, the auto balance module 500 retrieves only those cutoff periods that match the search criteria for the twenty-four-hour period specified. The user may desire to use this option if the ATM operator reconciles the ATM 20 once every business day.

The display options section preferably allows the user to select to display data corresponding to a most recent cutoff first. The display options section preferably also allows the user to display the data corresponding to a most recent cutoff last.

Once all the search criteria and display options are set, the user selects a search button or other user-operable control located on or otherwise associated with the ATM cutoff search screen 510. An ATM cutoff and balance sheet list screen 520 is preferably then displayed, in which a list is displayed of all cutoff periods for the specified ATM 20 falling within the date and time range specified by the user on the ATM cutoff search screen 510. The ATM cutoff and balance sheet list screen 520 preferably also displays any balance sheets that exist for the corresponding cutoff periods that are displayed on the list.

The ATM cutoff and balance sheet list screen 520 includes an identification information section and a grid of data section. The identification information section displays data corresponding to the cutoff period currently selected in the list of cutoff periods displayed on the grid of data section. The data displayed may include an ATM ID, an ATM street address, an ATM city, an ATM state, an ATM postal code, a financial institution ID, a financial institution name, and a current date. The grid of data section displays the list of cutoff periods that were located based on the search criteria defined by the user. The grid of data section displays data corresponding to each of the cutoff periods including an ATM ID, a cutoff date, a cutoff time, a balance sheet indicator, and an update required indicator. The balance sheet indicator indicates whether or not at least one balance sheet exists for the cutoff period displayed. More than one balance sheet may exist for each cutoff period (e.g., a separate balance sheet for each type of currency used in the ATM 20). In one embodiment a balance sheet icon indicates the presence of at least one balance sheet and an X shaped icon indicates that a balance sheet has not yet been processed for the cutoff period. The update required indicator indicates whether or not an update may be required. An update may be required if a late transaction or activity took place after the balance sheet was reconciled for the specified ATM 20 which may effect at least one of the totals displayed on the balance sheet. In one embodiment a “Y” indicates that an update may be required and a “N” indicates that no updates are required. If an update is required the user may proceed to review the relevant data to determine if an update needs to be made.

If the balance sheet indicator indicates that at least one balance sheet does exist, the user can either double click on the row of data corresponding to the desired cutoff period or the user can click a balance sheet button located on the ATM cutoff and balance sheet list screen 520. If the user performs either option an auto balance detail sheet screen 530 is displayed that illustrates all data corresponding to the selected cutoff period that is necessary to balance the specified ATM 20 for the selected cutoff period.

The auto balance detail screen 530 includes a number of tabs the user can utilize to perform reconciliation and functions related to the reconciliation process. The tabs may include at least one balance sheet tab 531, a possible exception transactions tab 532, an ATM counts tab 533, a captured card tab 534, a related administrative transactions tab 535, and an audit tab 536. The auto balance detail screen 530 also includes a cutoff period information section that displays data corresponding to the cutoff period that is displayed. The data that is displayed may include an ATM ID, a cutoff start date, a cutoff end date, an ATM address, an ATM city, an ATM state, an ATM postal code, a financial institution ID, a settlement type (e.g., ATM level and receptacle level), an updated by field, and an updated timestamp. The cutoff period information section remains constant regardless of what tab is currently displayed.

Each balance sheet tab 531 displays the data corresponding to currency amount that are used to reconcile the ATM 20. In one embodiment, a separate balance sheet tab 531 exists for each type of currency (e.g., a movie ticket balance sheet, a United States dollars balance sheet, a United States coinage balance sheet, and the like). In a related embodiment, a separate balance sheet tab 531 exists for each sub-type of currency (e.g., $10 bills, $20 bills, and the like). The balance sheet tab 531 includes three sections, a balancing currency dispensed section, a balancing ATM totals section, and an updated information section.

The balancing currency dispensed section includes a number of fields including user provided fields and auto balance module 500 provided fields. The user provided fields and the auto balance module 500 provided fields are utilized to develop a currency short, a currency over, or a currency reconciled amount.

The user provided fields include a total corresponding to the manual count performed (e.g., the amount of currency manually counted as being in the ATM 20 if the ATM 20 utilizes ATM level settlement, or the amount of currency manually counted as being in an individual receptacle if the ATM 20 utilizes receptacle level settlement), and a currency rejected/diverted total (again, either a total representative of the amount of currency in the entire rejected/diverted tray (ATM level settlement) or the amount of currency in the rejected/diverted tray that is representative of the currency from a particular receptacle (receptacle level settlement)).

The auto balance module 500 provided fields include a starting currency amount, a currency added amount, a currency subtracted amount, and a withdrawal amount. The starting currency amount, the currency added amount, and the currency subtracted amount are all typically available from data corresponding to the administrative transactions. The user may view additional data corresponding to these amounts under the related administrative transactions tab 535. The starting currency amount corresponds to the amount of currency in the ATM 20 at the beginning of the cutoff period. The currency added amount corresponds to any currency that was added by a courier during a currency add administrative transaction. The currency subtracted amount corresponds to any currency that was removed by a courier during a currency subtract administrative transaction. The currency added amount is added to the starting currency amount and the currency subtracted amount is then subtracted from that sum to generate a total currency amount. This calculation is performed automatically.

After the staff has completed the manual count of currency retrieved from the ATM 20, the user can utilize the totals from the manual count to enter values in the user provided fields. Once each user provided field is defined, a total manual currency count amount is generated (automatically). The total manual currency count is the sum of the receptacle currency count and the currency rejected/diverted total. The total manual currency count represents either the total amount of money from all of the receptacles and the rejected/diverted tray (ATM level settlement), or the total amount of money from one of the receptacles and the currency in the rejected/diverted tray that corresponds to that receptacle (receptacle level settlement). As discussed above, the type of settlement that is used depends upon the architecture of the ATM 20.

The total manual currency count amount is then subtracted from the total currency amount to generate (automatically) a calculated currency dispensed amount. The calculated currency dispensed amount is the amount of currency that the ATM 20 should have dispense based upon the amount of currency that should have been in the ATM 20 and the amount of currency that was remaining in the ATM 20 at the end of the cutoff period.

The balancing currency dispense section is utilized to obtain a currency over, currency short, or currency reconciled amount based on a withdrawal total obtained from a log which is created and maintained in the memory. As the processor 15 receives data corresponding to financial transactions occurring at the ATM 20, the log of the data is updated in the memory 40. As the log progresses, valuable information is available. One aspect of the valuable information is the amount of currency that was withdrawn from the ATM 20 during the cutoff period. An amount representative of the amount of currency withdrawn from the ATM 20 according to the log is displayed in a ATM withdrawal field. The amount in the ATM withdrawal field is subtracted from the calculated currency dispensed amount to generate (automatically) the currency over, the currency short, or the currency reconciled amount. If the value of that amount is null, the balance sheet is considered to be reconciled. If an out-of-balance (e.g., currency over amount or currency short amount), the user may utilize the possible exception transactions tab 535 to determine the reason for the out-of-balance condition.

The balancing ATM totals section performs a calculation similar to that performed in the balancing currency dispensed section. The difference between the two sections is the source of the data. The balancing currency dispense section utilizes the data from the log maintained in the memory. The balancing ATM totals utilizes data obtained from the ATM 20. The data may be received from the ATM 20 by the processor and stored in the memory 40 or transferred directly to the auto balance module 500 of the ATM management application 100 for use. Alternatively, the user may enter the data based on amounts calculated using the journal. A closeout receipt total is analogous to the calculated currency dispensed. Both values should indicate an amount of currency that was dispensed from the ATM 20. The closeout receipt total amount is obtained from the ATM 20. An ATM settlement amount is subtracted from the closeout receipt total to obtain a difference. The ATM settlement amount is analogous to the total manual currency count except that the ATM settlement amount is obtained from the ATM 20 and not through a manual count of the currency retrieved from the ATM 20. The difference is analogous to the currency over, currency short, or currency reconciled amount. The user may compare the two amounts to determine if the log and the ATM are recording information related to the financial transactions in a manner that produces similar results.

The updated information section displays data related to a transaction that occurred after the ATM 20 was reconciled and/or data related to an activity that may alter the reconciled balance sheet. Values may be displayed for starting currency, currency added, currency subtracted, ATM withdrawals, and ATM total. The user needs to review the balance sheet for any potential impact when values are displayed in the updated information section.

Activities that may alter the reconciled balance sheet are generally some type of auditing related activity. The user may view additional information about such activities under the audit tab as discussed below. Transaction may be viewed as occurring after the balance sheet was reconciled for a number of reasons. Generally, the data related to the transaction was received later than its receipt was anticipated. Data is communicated typically using either a batch delivery device or a real time feed device. A transaction may be viewed as occurring after the balance sheet was reconciled even if it was performed before the balance sheet was reconciled if the batch delivery occurs after data is requested by the auto balance module 500 or if the data becomes corrupted during its normal delivery and therefore needs to be recovered at a later time. The updated information section essentially allows the user to correct problems that arise due to circumstances that were not expected.

The possible exception transactions tab 532 consists of a list of possible exception transactions that may have caused an out-of-balance condition. The actual list of possible exception transaction is produced by an exception processing screen 810 of the other module 800. The interaction between the auto balance module 500 and the other module 800 (along with other inter-module interaction between each of the modules of the ATM management application 100) allows the user to more effectively manage the ATMs 20 the user is attempting to manage. Transactions are considered to be a possible exception transaction when the data received for the transaction includes an acquirer message reason code that indicates an exception transaction may have occurred. The acquirer message reason code triggers the exception processing screen 810 when the acquirer message reason code includes a card issuer timed out on original request code, a no communications key available for use code, an over dispense code, a suspected malfunction code, a completed partially code, a response received too late code, a card acceptor device unable to complete transaction code, an unable to deliver message to point of service code, a suspected malfunction and card retrained code, a suspected malfunction and card returned code, a suspected malfunction and no currency dispensed code, a timed out at taking money and no currency dispensed code, a timed out at taking card and card retained and no currency dispensed code, an invalid response and no action taken code, a timed out waiting for response code, and/or a partial reversal for incremental authorization code.

The possible exception transactions tab 532 displays data corresponding to the possible exception transactions including a new indicator, an account number, a transaction date, a transaction time, an acquirer message reason code description, a net reconciliation amount with fee, a retrieval reference number, an ATM ID, a local date, a local time, and the like. If the user desires to view more detailed data about the transaction, a transaction list screen 820 and subsequently a transaction detail screen 825 of the other module 800 can be displayed. The user either double clicks the row corresponding to the possible exception transaction or clicks on a view transaction button located on the possible exception transactions tab to access the detailed data.

If the user is able to identify a transaction that has at least in part caused the out-of-balance condition, the user can process the exception accordingly using the exception processing screen 810.

The ATM counts tab 533 displays data corresponding to the currency contained and/or dispensed from each of the receptacles of the ATM 20. Although summary totals data is displayed on the balance sheet tab, the user may find receptacle specific data more beneficial under some circumstances. The data displayed is representative of data obtained from the ATM 20. The data displayed may include the type of currency (and sub-type of currency) in each receptacle that is active in the ATM 20, a count of the currency in the receptacle at the start of the selected cutoff period, a count of the currency in the receptacle at the end of the selected cutoff period, a count of the currency dispensed during the selected cutoff period, an amount of currency corresponding to any of the counts, and the like. The ATM count tab 533 may also include similar type data for the rejected/diverted currency in the ATM 20.

The captured cards tab 534 displays captured card data corresponding to the cards captured in the ATM 20 during the selected cutoff period. The captured cards tab assist the user in processing of the captured cards. The captured cards data displayed may include a cardholder number, a cardholder name, an action code (e.g., card destroyed, card returned to ATM customer, card returned to ATM operator, card not located, and the like), an ATM ID, and a cutoff date.

The user can add and/or update captured card data on a captured card maintenance screen 540. The user may add captured card data to indicate when a captured card is received by the ATM operator. A captured card may be received by the ATM operator at the same time the courier delivers the canisters and the journal to the ATM operator for reconciliation. The user may also add captured card data when an ATM customer contacts the ATM operator to report a captured card that is not included in the captured card data displayed. A user may update captured card data if the captured card data has changed. Captured card data may change, for example, when a captured card is delivered to the ATM customer and/or the financial institution the ATM customer is associated with (i.e., change in action code).

Data maintained on the captured card tab 534 is used primarily as an audit trail. Generally, when the card of an ATM customer is retained by the ATM 20, the ATM customer contacts the financial institution that issued the card. The user can access the captured card data to determine why the card was retained and if a new card should be issued to the individual.

The related administrative transactions tab 535 displays administrative transactions data corresponding to the administrative transactions that occurred at the ATM 20 during the selected cutoff period. Administrative transactions may include currency adds, currency subtracts, currency resets, and the like. Typically, when a courier performs an administrative transaction, the courier utilizes a card similar to those used by ATM customers. The card the courier utilizes is read by the card reader located on the ATM 20 and the courier inputs data corresponding to the administrative transaction using the keypad located on the ATM 20.

The administrative transactions data displayed may include an administrative transaction code (e.g., currency reset, currency add, currency subtract), a date of the administrative transaction, a time of the administrative transaction, a courier card number, a courier name, a courier route, a retrieval reference number, a total amount of currency in the ATM 20 at the time of the transaction, a total amount of currency in each receptacle of the ATM 20 at the time of the transaction, a currency code for each receptacle, a count for each receptacle, a value for each receptacle, and the like.

The audit tab 536 displays audit data corresponding to all changes in data and/or information that have occurred on each balance sheet for the selected cutoff period. Audit data that is displayed on the audit tab may include an ATM ID, a balance sheet description (e.g., United States dollars balance sheet, United States coinage balance sheet, movie tickets balance sheet), a date created, a time created, an updated by field (indicates the user that made the change), an updated timestamp, a field name (indicates the field where a change was made), an old value, a new value. The audit tab provides the user with audit data that allows the user to determine the changes that have been made to a balance sheet and whether or not the changes are warranted. The audit tab 536 assists the ATM operator in making the staff more accountable. The increased accountability results in fewer errors in the reconciliation process and thereby fewer expenses (e.g., write-offs, exception penalties, and the like) for the ATM operator.

The deposit verification module 600 assist the user in performing deposit verification for an ATM 20. When an ATM customer performs a deposit transaction using an ATM 20, the ATM customer inserts currency into an envelope and deposits the envelope into an envelope deposit slot located on the ATM 20. The ATM customer is prompted by the display screen of the ATM 20 to indicate the value of the currency placed in the envelope using the keypad located on the ATM 20. The amount of currency electronically noted by the ATM customer using the keypad is then included in the journal of transactions that is associated with the ATM 20. Ideally, the amount of currency the ATM customer inserted in the envelope corresponds to the amount of currency electronically noted by the ATM customer. Deposit verification is the process of determining if the two amounts of currency correspond.

Presently, deposit verification includes comparing each envelope to the journal retrieved from the ATM 20. The staff of the ATM operator that performs deposit verification locates each deposit transaction on the journal and then finds the envelope that corresponds to that transaction. The ATM customer typically places an identifier (e.g., ATM customer name, financial institution name, account number, and the like) on the envelope for identification by the staff. The amount of currency in the envelope is compared to the corresponding amount noted on the journal. The deposit is considered verified if the amount of currency in the envelope is equal to the amount of currency noted on the journal. If the two amounts are not equal, the staff make note of the discrepancy and process the discrepancy accordingly (e.g., create an exception using the other module 800). A discrepancy may exist for a number of reasons including an empty envelope, an amount improperly entered by the ATM customer, a miscount of the amount of currency in the envelope by the ATM customer, attempted fraud by the ATM customer, and the like.

Deposit verification is generally a time consuming manual process. The staff of the ATM operator that perform the deposit verification process is commonly the same staff that perform the reconciliation process. This staff generally experience a high turnover rate, thereby requiring the ATM operator to constantly train new staff. The manual aspects of the deposit verification process coupled with a lack of discipline by the staff may result in audit issues, write-offs, and high exception penalties for the ATM operator. The deposit verification module 600 provides the user with an automated system that effectively manages deposit verification of an ATM 20. The deposit verification module 600 reduces the amount of training needed to accomplish deposit verification, reduces the number of write-offs the ATM operator must make as a result of processing errors, and increases the likelihood of a balanced deposit verification sheet.

The deposit verification module 600 generates a log of deposit transactions that corresponds to each deposit transaction that was performed by ATM customers at the ATM 20. In one embodiment, the log is stored in the memory 40 and is updated as data corresponding to each deposit transaction is received by the processor 15. The log of deposit transactions is then used in the deposit verification process to verify each deposit transaction. As deposit transactions are verified, they are added to a deposit verification sheet. A number of deposit verification sheets may be used for each cutoff period.

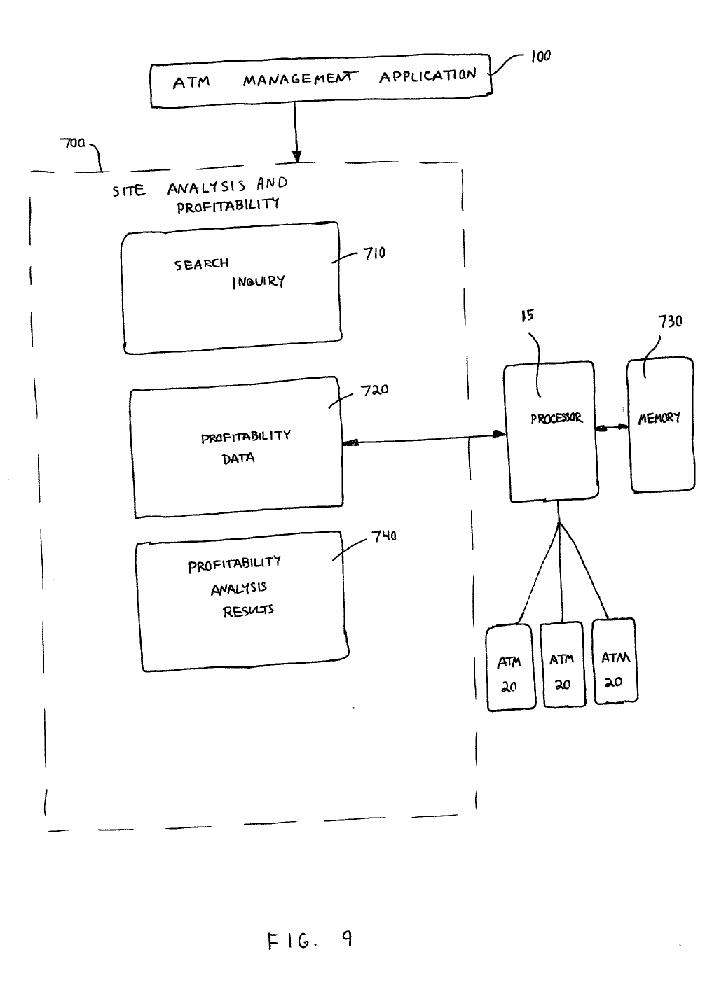

To utilize the functions provided by the deposit verification module 600, the user first selects the deposit verification module 600 of the ATM management application 100. As illustrated in FIG. 8, a deposit verification screen 805 is displayed that allows the user to access a deposit verification sheet search screen 810 and a create new deposit verification sheet screen 820. Each screen that is accessible through the deposit verification screen 805 allows the user to perform functions related to managing deposit verification.

The user can utilize the deposit verification sheet search screen 810 to define search criteria including a specific ATM 20 and a period of time that is used to qualify a search for deposit verification sheets associated with the specific ATM 20. Generally, the user searches for deposit verification sheets for a specific ATM 20 so that the user can perform deposit verification of the ATM 20. The user may also access the data available using the deposit verification module 600 for other reasons. The deposit verification sheet search screen 810 includes a primary search section, a date and time options section, and a display options section.

The primary search section allows the user to select the specific ATM 20. The user selects the specific ATM 20 by selecting an ATM ID from a box list associated with the field. The user may perform a search for a particular ATM ID if needed. The ATM ID is a value that uniquely identifies the ATM 20 for which a deposit verification sheet is needed. The ATM ID may represent a single ATM 20 or a group of ATMs 20.

The date and time options section allows the user to define the period of time that is used to search for deposit verification sheets associated with the specific ATM 20. The user enters a start business date and an end business date. The options available for automatically generating the period of time are similar to those discussed with respect to the ATM cutoff search screen 510 of the auto balance module 500.

The display options section allows the user to select to display the data corresponding to the most recent deposit verification sheet first. The display options section also allows the user to select to display the data corresponding to the most recent deposit verification sheet last.

Once all the search criteria and display options are set, the user clicks on a search button located on the deposit verification sheet search screen 810. An ATM deposit verification sheets screen 812 is then displayed that includes an identification information section and a grid of data section. The grid of data section includes two tabs, a deposit verification sheets tab 813 and an audit information tab 814.

The identification information section displays data corresponding to the deposit verification sheet currently selected in the list of deposits verification sheets that is displayed on deposit verification sheets tab 813 of the grid of data section. The data displayed may include an ATM ID, an ATM street address, an ATM city, an ATM state, an ATM postal code, a financial institution ID, a financial institution name, a business date, a sequence of the selected deposit verification sheet (e.g. 2 of 3), a verified count (i.e., the number of deposits verified on the selected deposit verification sheet), a date and time of the first deposit transaction listed on the selected deposit verification sheet, a date and time of the last deposit transaction listed on the selected deposit verification sheet, a verified cardholder (i.e., ATM customer) entered amount, a verified actual amount, and the like.

The deposit verification sheets tab 813 of the grid of data section displays the list of deposit verification sheets that were located based on the search criteria defined by the user. The deposit verification sheets tab 813 displays data corresponding to each of the deposit verification sheets including an ATM ID, a business date, a sequence number, a user ID, a verified cardholder amount, a verified actual amount, a verified envelope count (i.e., the number of deposit envelopes counted at the back office), an original envelope count (i.e., the number of deposit envelopes counted at the ATM upon retrieval), a start date and time of the deposit verification sheet, an end date and time of the deposit verification sheet, a sheet last updated (i.e., identifies the last date the deposit verification sheet was updated), and the like.

The audit information tab 814 of the grid of data section displays data corresponding to any updates made to the deposit verification sheet selected on the deposit verification sheets tab 813. The data displayed may include a column name, a date and time updated, an updated by, a local date and time (i.e., when the deposit transaction occurred at the ATM 20), a new value, an old value, an account number, and a retrieval reference number.

The user may view a list of the deposit transactions that are included on the selected deposit verification sheet by double clicking on the row of data corresponding to the deposit verification sheet or by clicking a deposit list button located on the deposit verification sheets tab 813. If the user performs either option a deposit transactions list screen 816 is displayed that includes an identification information section and a grid of data section. The grid of data section includes two tabs, a deposit transactions tab 817 and a deposit audit information tab 818.

The identification information section displays data corresponding to the deposit transaction currently selected in the list of deposits transactions that is displayed on deposit transactions tab 817 of the grid of data section. The data displayed may include data similar to the data displayed on the identification information section of the ATM deposit verification sheets screen 812.

The deposit transactions tab 817 of the grid of data section displays the list of deposit transactions that were located based on the search criteria defined by the user. The deposit transactions tab 817 displays data corresponding to each of the deposit transactions including a verified indicator, an account number, a cardholder entered amount, a verified actual amount, a retrieval reference number, an ATM ID, a reason code (i.e., a reason the amount of the deposit transaction was changed, e.g., empty envelope, invalid currency, incorrect deposit amount, and the like), an updated by, and an updated date and time. The verified indicator indicates whether or not the deposit transaction has been verified. In one embodiment a deposit verification sheet icon indicates the deposit transaction is verified and processed, a check mark shaped icon represents the deposit transaction is verified but not processed, and an X shaped icon represents the deposit transaction is not verified or processed.

The deposit audit information tab 818 of the grid of data section displays data corresponding to any updates made to the deposit transaction selected on the deposit transactions tab 817. The data displayed may include a column name, a date and time updated, an updated by, a local date and time (i.e., when the deposit transaction occurred at the ATM 20), a new value, an old value, an account number, and a retrieval reference number.

The user can perform a number of functions related to deposit verification using the deposit transactions list screen 816. These functions include retrieving unverified deposit transactions, verifying unverified deposit transactions, processing a deposit verification sheet to include data corresponding to verified but unprocessed deposit transactions, removing verified deposit transactions from a deposit verification sheet, moving verified deposit transaction to a different deposit verification sheet, adding a deposit transaction, editing a deposit transaction, and accessing a create new deposit verification sheet screen 820 to create a new deposit verification sheet (as discussed below).

Generally, when the user first views the deposit transactions list screen 816 only verified deposit transactions are displayed in the list of deposit transactions on the deposit transactions tab 817. In one embodiment, unverified deposit transactions are not displayed on the list because only verified deposit transactions are considered to be included on the deposit verification sheet. The user may select to retrieve all unverified deposit transactions that may be associated with the deposit transaction sheet that is currently displayed. The user retrieves the unverified deposit transactions by clicking a retrieve unverified deposit transactions button located on the deposit transactions list screen 816. If unverified deposit transactions exist they are retrieved and displayed on the list as being unverified (i.e., X shaped icon in the verified indicator field of the grid of data).

If the user has the envelope that corresponds to the unverified deposit transaction, the user can review the amounts of currency to determine if the amounts are equal. If the amounts are equal the user can verify the unverified deposit transactions by clicking on the verified indicator field. The X shaped icon changes to the check mark shaped icon thereby illustrating that the previously unverified deposit transaction is now a verified deposit transaction. If the amounts are not equal, the user may need to edit the deposit transaction.

If the user determines that the data displayed corresponding to a particular deposit transaction is not correct (e.g., the amount of currency noted as being in the envelope is not correct), the user can edit the deposit transaction by clicking on an edit deposit transaction button located on the deposit transactions tab 817. An add/update deposit item for deposit verification screen 825 is displayed. The user can then update any of the fields to correctly indicate the standing of the deposit transaction. The fields that can be updated may include an ATM ID, a deposit transaction date and time, an account number, a retrieval reference number, a deposit transaction type ID, a cardholder entered amount, a verified actual amount, a cardholder currency type (i.e., the type of currency in the envelope), a reason code, and a comments field. The user may enter any free-form alphanumeric message to describe the deposit transaction using a comments field on the add/update deposit item for deposit verification screen 825. The field that most often needs to be updated is the verified actual amount. In one embodiment the verified actual amount is defaulted to the cardholder entered amount. If the amount of currency counted from the envelope differs from the amount of currency displayed in the verified actual amount field, the updates that field to reflect the amount of currency that was counted from the envelope. If after performing an update the verified actual amount equals the cardholder entered amount the user may subsequently verify the deposit transaction as discussed above. If the verified actual amount is not equal to the cardholder entered amount, the user can create an exception using the exception processing screen 810 of the other module 800 by clicking a create exception button located on the add/update deposit item for deposit verification screen 825. If an exception already exists, the user can view the exception by clicking on a view exception button also located on the add/update deposit item for deposit verification screen 825. If the user would like to view additional information about the deposit transaction, the user can click a view transaction button located on the add/update deposit item for deposit verification screen 825. The user is linked to the transaction list screen 820 of the other module 800. More detailed data concerning the deposit transaction can then be viewed on the transaction detail screen 825 of the other module 800. Once the user has finished updating the fields, the user clicks a process button located on the add/update deposit item for deposit verification screen 825 which thereby includes the updated deposit transaction data on the deposit verification sheet. The user then returns to the deposit transactions tab 817.

If the user has an envelope for which no deposit transaction exists, the user can create a new deposit transaction using the add/update deposit item for deposit verification screen 825. The user accesses the add/update deposit item for deposit verification screen 825 by clicking on an add deposit transaction button located on the deposit transactions tab 817. The user then enters all required fields and clicks the process button to add the deposit transaction to the deposit verification sheet. Although the new deposit transaction is not verified and therefore not considered part of the deposit verification sheet, the deposit transaction is displayed in the list and identified as being unverified.

The user can move a verified deposit transaction to another deposit verification sheet by clicking a move deposit transaction button located on the deposit transactions sheet tab 817. A move deposit transaction to a different deposit verification sheet screen 830 is displayed. The user can select a different deposit verification sheet ID from a box list associated with the different deposit verification sheet ID field to define which existing deposit verification sheet the deposit transaction should be moved to. When the user is completed defining the different deposit verification sheet ID the user selects a process button located on the move deposit transaction to a different deposit verification sheet screen 830 and is then transferred to the deposit transactions list screen 816 corresponding to the selected deposit verification sheet ID. Only a verified deposit transaction can be moved because as discussed above, an unverified transaction is not considered to be included on a deposit verification sheet. The user may move a deposit transaction to a different deposit verification sheet if the deposit transaction was originally entered on the wrong deposit verification sheet.

The user can remove a verified deposit transaction from the deposit verification sheet by clicking a remove deposit transaction button located on the deposit transactions sheet tab 817. If the user clicks the remove deposit transaction button the user is prompted to answer if they desire to remove the selected deposit transaction from the deposit verification sheet. If the user clicks the OK button on the prompt message the selected deposit transaction is removed. Only a verified deposit transaction can be removed from a deposit verification sheet because as discussed above, an unverified transaction is not considered to be included on a deposit verification sheet. A user may remove a deposit transaction from a deposit verification sheet if the deposit transaction is not needed (e.g., log of deposit transactions includes two entries for the same deposit transaction).

Once the user has completed verifying all deposit transactions on a displayed deposit verification sheet, the user can process the deposit verification sheet to include data corresponding to verified but unprocessed deposit transactions. Essentially, by processing the verified but unprocessed transactions, the user is including the deposit transaction in the deposit verification sheet. Once the deposit verification sheet is processed all verified but unprocessed deposit transactions are verified and processed deposit transactions and thus the verified indicator identifies the deposit transaction with the deposit verification sheet icon.

The user can utilize the create new deposit verification sheet screen 820 to create a new deposit verification sheet if a deposit verification sheet does not currently exist for the specific ATM 20 on the specific business date. The create new deposit verification sheet 820 includes a primary search section and a display options section.

The primary search section allows the user to select the specific ATM 20 and the specific business date. The user selects the specific ATM 20 by selecting an ATM ID from a box list associated with the field. The user may perform a search for a particular ATM ID if needed. The ATM ID is a value that uniquely identifies the ATM 20 for which a deposit verification sheet is needed. The ATM ID may represent a single ATM 20 or a group of ATMs 20. The user selects the specific business date by entering a date in a MM/DD/YYYY format. In one embodiment, the current date is listed as the default business date.

The display options section allows the user to select to display the data corresponding to the most recent deposits first. The display options section also allows the user to select to display the data corresponding to the most recent deposits last.

Once all the search criteria and display options are set, the user clicks on a process button located on the create new deposit verification sheet screen 820. An ATM deposit transactions list screen 816 is then displayed (as discussed above). Each unverified deposit transaction that could be associated with the newly created deposit verification sheet is displayed on the deposit transactions tab 817 of the grid of data section.

Some embodiments of the present invention employ a profitability module 700 for determining the profitability of one or more ATMs 20. The information provided to the user by the profitability module 700 can be used to assess existing ATMs 20 as well as to help determine the potential profitability of one or more proposed ATMs 20.

Currently, the determination of an ATM's profitability is typically made employing a time-intensive process of comparing ATM costs to ATM revenue over a period of time. This process is subject to error in a number of ways, including error during the data entry process followed to calculate costs and revenues, error from failing to take into consideration all costs of operating and maintaining an ATM, and error in failing to perform profitability calculations consistently for different ATMs. Since placement of ATMs is extremely competitive, ATM operators need to understand what locations work and what locations do not work. Therefore, and because the profitability analyses performed upon an ATM are often heavily relied upon by ATM operators, such profitability analyses must be reliable, consistent, and must take into account all factors in an ATM's operating and maintenance costs.

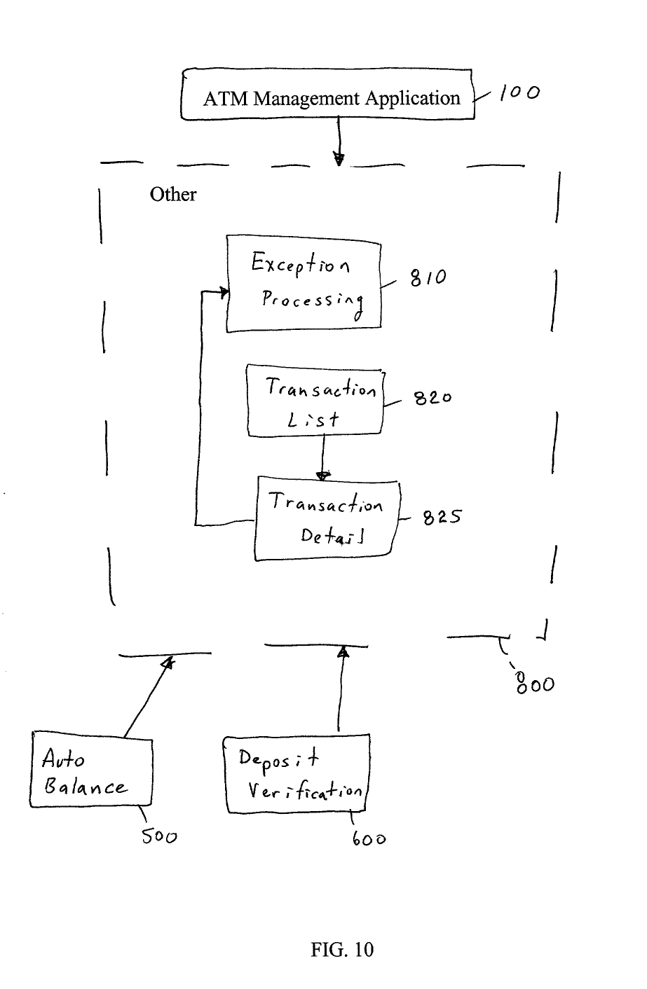

One example of a site analysis and profitability management module 700 is illustrated in FIG. 9. To utilize the functions provided by the site analysis and profitability module 700, the user in some embodiments of the present invention can select the status inquiry module 300 of the ATM management application. The site analysis and profitability module 700 can have an search inquiry screen 710 wherein a user can perform searches for ATMs 20 connected to the processor 15 meeting one or more search criteria set by the user. In this manner, the user can select those ATMs 20 for which a profitability analysis will be performed. The search inquiry screen 710 can have any number of fields for user input of search criteria. By way of example only, the fields can include ATM location (e.g., city, state, postal code, and the like), ATM identifier, merchant identifier, financial institution, processor responsible for processing transactions performed by the ATM 20, ATM state (e.g., search for all ATMs that are currently inoperative), and the like. Although the search inquiry screen is not required for the site analysis and profitability module 700, such a feature permits a user to more quickly identify one or more ATMs for which a profitability analysis is to be performed. If a search inquiry screen 710 is not employed, the profitability module 700 can instead have a lookup table or list by which a user can select one or more ATMs 20 connected or connectable to the processor 15 for performing a profitability analysis.

After an ATM or group of ATMs has been selected by the user, some preferred embodiments of the present invention can display a profitability data screen 720 in which the user and/or the processor 15 can provide and display data used to determine the profitability of the ATM or group of ATMs. The following discussion is with reference to a profitability analysis performed for one selected ATM, although it should be noted that a similar analysis can be performed for a group of ATMs.

In some preferred embodiments, the profitability data screen 720 displays a number of data fields containing information regarding the costs associated with the selected ATM. These costs can be located in one section of the profitability data screen 720 or can be located in a separate screen (in which case the profitability data screen 720 is split into two or more screens). The costs displayed on the profitability data screen 720 can include any or all of the following costs often associated with operating and maintaining an ATM: telecommunications costs for communication of ATM to network; cost of courier service to the ATM; maintenance costs for the ATM; cost of currency in the ATM; ATM installation and setup costs; ATM equipment costs; ATM administration costs; and network fees associated with the ATM's operation. Still other costs can be included in the profitability data screen 720 as desired.

Preferably, the estimated costs are retrieved by the processor 15 from a memory 730 associated with or otherwise connected to the processor 15. These estimated costs can be industry defaults that are stored and are more preferably updated and maintained in a database in the memory 730. In addition or instead, these estimated costs can be set by a user based upon knowledge of the costs for existing ATMs (e.g., the monthly telecommunications costs of the ATM 20, the cost of currency for the ATM, and the like).

It will be appreciated by one having ordinary skill in the art that a number of the costs mentioned above can vary from ATM to ATM based upon a number of factors. Therefore, although default data can be retrieved by the processor 15 in some embodiments as described above, the fields in which the ATM costs are displayed preferably permit a user to change the costs as desired. Such changes can be made by the user directly inputting a desired cost into a cost field (thereby either filling a blank field or overwriting a default figure input into the field by the processor 15). Alternatively or in addition, such changes can be automatically made in response to the user inputting other data into one or more fields related to a cost on the profitability data screen 720. Specifically, a cost on the profitability data screen 720 can have associated with it one or more other fields that can be completed by the user to generate a cost in the field via a subroutine.

For example, a field for the cost of courier service to the ATM can have associated with it a field for the frequency of courier visits to the ATM and the location of the ATM (both factors in determining the cost of courier service to the ATM). These fields can be automatically filled by the processor 15 retrieving default information from the memory 730 and/or or can be filled in or changed by the user. The processor 15 can then follow a subroutine to retrieve courier costs based upon this information, such as from a table or other database available to the processor 15. As another example, a field for the ATM equipment costs can have associated with it a field for the model of ATM used. The ATM model field can be a table from which an ATM model can be selected or can be any other selector by which the user can identify the type of ATM. As yet another example, the cost of currency field can have associated with it a prime interest rate field, a supplemental interest rate field, and/or a field for the currency on hand amount at the ATM. Entry of data in any or all of these fields by a user can trigger a subroutine associated with these fields to automatically calculate the cost of currency in the ATM based upon known cost of currency formulas. The data in any or all of these fields can be changed by a user from default data retrieved by the processor 15 from the memory 730. Alternatively, any or all of these fields can be initially empty for filling by the user.

In some preferred embodiments of the present invention, the profitability data screen 720 displays the revenue generated by the ATM over a period of time. This revenue can be displayed in any number of different fields as desired. Fields reflecting this revenue can include the amount of ATM surcharge revenue received by the ATM (whether presented as a sum total of revenue and/or as an amount of revenue generated per transaction and the number of transactions in which a surcharge was assessed) and any other revenue fields reflecting income received from the ATM. The revenue data for the ATM can be obtained in a number of different manners. Most preferably, this revenue data is obtained from a memory (for example, memory 730) in which such data is stored and is preferably updated by processor connection to and communication with the ATM. Specifically, transaction data of the ATM is preferably stored in the memory 730 either during each transaction of the ATM 20, following each transaction of the ATM 20, or in batch form following a number of transactions of the ATM 20.

Most preferably, communication is established between the ATM 20 and the processor 15 to facilitate the transmission of this data from the ATM 20 to the processor 15 and to the memory 730 where the transaction data is stored. The transmission can be via any number of telecommunications networks, and can include transmission via satellite, fiber-optic, telephone lines, wireless transmission, and the like. The transaction data transmitted preferably includes the information needed to determine the revenue generated by the ATM 20 over a period of time. For example, this transaction data can include the date of the transaction, whether a surcharge was assessed by the ATM 20 in the transaction, and the amount of the surcharge. Other information such as the transaction time, the ATM user, and the like can also be transmitted and stored in the memory 730 if desired.

Although in the preferred embodiment illustrated in FIG. 9 the memory 730 (in which the cost data and/or the revenue data for the ATM is stored) is preferably in the same location as the processor 15, in other embodiments the memory 730 can be located at the ATM 20 or in a location that is remote from both the ATM 20 and the processor 15. Also, the memory 730 can be defined by multiple memories in the same or different locations, such as a memory at the location of the processor and a memory in the ATM 20.

By virtue of the connection between the processor 15, the ATM 20, and the memory 730, data regarding the revenue generated by the ATM 20 over a period of time can be stored in the memory 730 and can be referenced by the processor 15 for completing revenue fields of the profitability data screen 720. The communication between the processor 15, the ATM 20, and the memory 730 enables rapid access to accurate revenue information for profitability analyses by the profitability management module 700.

Like at least some of the cost fields for the ATM 20 as described above, some embodiments of the present invention permit a user to change one or more revenue data fields as desired. By way of example only, a user can change the surcharge amount in a surcharge field of the profitability data screen 720 or can change the number of transactions in which a surcharge was assessed in a transaction number field of the profitability data screen 720 in order to determine the impact such changes make to the profitability of the ATM 20. Still other field changes can be made to enable a user to determine ATM profitability based upon different revenue variables of the ATM 20.

At least some of the cost and revenue fields of the profitability data screen 720 are filled in by the processor 15 following selection of an ATM 20 for which a profitability analysis is desired. In some highly preferred embodiments, all cost and revenue fields (or at least those for which data are available) are automatically filled and displayed for a user by processor reference to the memory 730 in which the ATM transaction data and ATM costs are stored. In other embodiments, some (or even all) of the cost or revenue fields are left blank for manual entry by a user. Also, at least some of the cost and revenue fields can preferably be manually changed by a user as desired in order to determine the impact that such changes have upon an ATM's profitability. Such determinations can be made for profitability assessments of existing ATMs as well as for profitability predictions for new and proposed ATMs 20.

A third set of fields preferably located in the profitability data screen 720 is a profitability analysis date range. Although in some embodiments a default date range (such as a calendar month or year), most preferably the user is able to define a time period over which the ATM's profitability will be determined. The date range fields therefore preferably include a start date and an end date that can be manually entered and changed by a user. Preferably, any date range can be specified.

After all desired cost, revenue, and date range fields have been filled, a button or other control can be operated by a user to generate a profitability analysis results screen 740. The profitability analysis results screen 740 can display the profitability of the ATM 20 in a number of different manners and formats. In some preferred embodiments, the net profit or loss is displayed on the profitability analysis results screen 740, and is calculated by the processor 15 by subtracting all ATM costs from all ATM revenues for the period of time specified by the user in the date range as described above. The net profit or loss can be presented for just the date range specified in the profitability data screen 720, for a day, or for a calendar month or year, or for any other period of time desired. Profitability results for two or more ranges of time can also be simultaneously displayed (such as profitability for the date range specified in the profitability data screen 720 and profitability for a calendar year). In this regard, the profitability analysis results screen 740 can have one or more user-manipulatable controls for changing the range for which the profitability analysis is presented.

The profitability analysis results screen 740 can also display any or all of the cost and revenue data used to calculate the profitability presented on the profitability analysis results screen 740. This data can be the same as the data in the fields of the profitability data screen 730 or can be in another format (e.g., all fields adjusted to reflect the cost or revenue for the date range period specified by the user). In some preferred embodiments, one or more user-manipulatable controls exist for returning to the profitability data screen 720, thereby enabling a user to change the data in one or more fields in the profitability data screen 720. In alternative embodiments, the cost and revenue data on the profitability data screen 720 can itself be changed to determine the impact such changes have upon the profitability analysis.

It should be noted that the various screens 710, 720, 740 described herein can be arranged in formats that are different than that described above. By way of example only, the profitability data screen 720 and the profitability analysis results screen 740 can be located on the same screen rather than being on different screens as described above. As another example, any of the information described above can be presented on multiple screens or can even be presented in a format that is not screen-based.

Although it is desirable to view the revenue, cost, and date range information prior to performing a profitability analysis as described above, the profitability analysis process can be changed so that selection of one or more ATMs 20 (e.g., from the search inquiry screen 710) automatically generates a profitability analysis without first displaying the revenue, cost, and date range information for the selected ATM. In such a case, all revenue and cost information can be retrieved for a default date range and for an automatic profitability analysis. In such embodiments, the user is preferably still able to change one or more fields as described above in order to display the analysis in a different manner or to determine the impact such changes make upon profitability of the selected ATM 20.

As mentioned above, the process of determining the profitability of two or more ATMs 20 is preferably similar to that of determining the profitability of one ATM 20. In this regard, multiple ATMs are preferably selected by the user, whether by a search inquiry screen 710 or otherwise. The profitability data screen 720 for a first of the two or more ATMs can then be displayed for the user in a manner similar to the process described above with reference to a one-ATM analysis. The capabilities of a user to manipulate data in the fields of the profitability data screen 720 are preferably the same as those described above with reference to a one-ATM analysis.

Preferably, one or more user-manipulatable controls can be operated by the user to simultaneously view the cost and revenue information for multiple ATMs 20 or to navigate through profitability data screens 720 for individual ATMs selected for profitability analysis by the user. As an alternative to viewing the cost and revenue data for each individual ATM, other embodiments of the present invention can instead or in addition enable corresponding cost and revenue fields of the selected ATMs to be added together to generate aggregate cost and revenue fields for the group of selected ATMs. This information can then be displayed for the user in an aggregate profitability data screen 720 similar to the individual ATM profitability data screen 720 described above.

After display of one or more profitability data screens 720 (when multiple ATMs 20 have been selected for profitability analysis as described above), the user can generate the profitability analysis by one or more user-manipulatable controls. The profitability analysis can be presented in a number of different manners, such as in a number of profitability analysis result screens 740 each corresponding to an ATM 20 selected for analysis or in an aggregate profitability analysis result screen 740 for all ATMs 20 selected. The fields and information displayed can be any of those described above with reference to the single ATM profitability analysis. Also, the capabilities of a user to manipulate data in the fields of the profitability data screen 720 are preferably the same as those described above with reference to a one-ATM analysis. When a profitability analysis result screen 740 is generated for each selected ATM 20, the user can preferably navigate through the screens to view the results of each selected ATM 20. Otherwise, the profitability results of multiple ATMs 20 can be viewed simultaneously in other preferred embodiments.

When an aggregate profitability analysis result screen 740 is generated for a group of selected ATMs 20, the fields displayed for viewing by the user can be generated by adding the corresponding fields for the individual ATMs 20. In some highly preferred embodiments, the user can change the display to selectively view aggregate results of profitability for multiple selected ATMs or to view individual results of profitability for individual ATMs from the selected group of ATMs.

In some preferred embodiments of the present invention, the processor 15 running the site analysis and profitability management module 700 and performing the operations and calculations related thereto is located at the site of a computer coupled to one or more remote ATMs 20 via one or more telecommunications lines (e.g., via satellite, fiber-optic, telephone lines, wireless transmission, and the like). However, in other embodiments, the processor 15 performing these functions can be a processor of a computer that is coupled to a host computer which is itself coupled to one or more ATMs 20.

An important example of such an application is the case of a service provider having a computer that is coupled to and is used to monitor and manage one or more ATMs 20. Customers of the service provider can connect to this computer with their own computers and can thereby obtain necessary data for making profitability analyses. The processor 15 running the profitability management module 700 and performing the operations and calculations related thereto can therefore be located at the service provider's computer or at the customer's computer. In some other applications, the processor 15 can even be located in the ATM 20 for which the profitability analysis is run. In addition, the processor 15 performing the above-noted functions can be defined by multiple processors in the same location or in different locations (e.g., one in a service provider's computer and one in a customer's computer connected thereto).

Like the memory 720 described above, operation of the site analysis and profitability management module 700 is not limited by the form and location of the processor 15. However, in one preferred embodiment, the processor 15 is located at the customer's remote computer, which retrieves at least some of the cost and revenue data from a host computer of the service provider as needed for making profitability analyses at the customer's computer. The host computer in turn obtains at least some of this cost and revenue data from the connected ATMs 20 and stores such information in a memory 720 as described above.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

What is claimed is:

1. A method of managing an ATM, comprising:
providing a processor adapted to be coupled to an ATM, the ATM including a receptacle configured to retain a range of currency amounts between and including an empty currency amount and a full currency amount;
receiving first data from the ATM, wherein the first data corresponds to a first amount of currency in the receptacle between the empty currency amount and the full currency amount;
storing the first data in a memory associated with the processor;
receiving a transaction request at the ATM;
changing the first amount of currency in the receptacle to a second amount of currency in response to the transaction request, wherein the second amount of currency in the receptacle is between the empty currency amount and the fall currency amount;
receiving second data from the ATM, the second data corresponding to the second amount of currency in the receptacle;
storing the second data in the memory associated with the processor;
receiving a query for at least one of the first data and the second data; and
outputting data corresponding to the at least one of the first data and the second data in response to the query.

2. The method as claimed in claim 1, further comprising:
receiving additional transaction requests at the ATM;
changing currency amounts in the receptacle to different currency amounts in response to at least some of the additional transaction requests;
receiving additional data from the ATM, the additional data corresponding to the different currency amounts;
storing the additional data in the memory associated with the processor;
receiving a query for at least one of the first data, the second data, and the additional data; and
outputting data corresponding to the at least one of the first data, the second data, and the additional data.

3. The method as claimed in claim 2, wherein receiving additional data from the ATM occurs during each transaction performed by the ATM.

4. The method as claimed in claim 2, wherein receiving additional data from the ATM occurs after each transaction performed by the ATM.

5. The method as claimed in claim 2, wherein receiving additional data from the ATM occurs during at least some transactions performed by the ATM.

6. The method as claimed in claim 2, further comprising:
receiving a query for a history of currency amounts in the ATM; and
outputting data corresponding to the history of currency amounts at the ATM.

7. The method as claimed in claim 2, wherein the processor is coupled to a plurality of ATMs, the method further comprising repeating all receiving, storing, and changing steps for each of the plurality of ATMs.

8. The method as claimed in claim 7, wherein the query is a query for at least one of the first data, the second data, and the additional data of at least some of the plurality of ATMs.

9. The method as claimed in claim 8, wherein:
receiving a query includes receiving a query for a history of currency amounts in at least some of the plurality of ATMs; and
outputting data includes outputting data corresponding to the history of currency amounts in the at least some of the plurality of ATMs.

10. The method as claimed in claim 1, wherein:
the receptacle is one of at least two receptacles configured to retain respective ranges of currency amounts between and including respective empty currency amounts and full currency amounts; and
the first and second data farther correspond respectively to first and second amounts of currency in each receptacle between the empty currency amounts and the full currency amounts.

11. The method as claimed in claim 1, wherein:
receiving a query includes receiving a query for a history of currency amounts in the ATM; and
outputting data includes outputting data corresponding to the history of currency amounts in the ATM.

12. The method as claimed in claim 11, wherein the query is a query for data corresponding to a plurality of successive transactions performed by the ATM.

13. The method as claimed in claim 10, wherein the query is a query for data corresponding to all transactions performed by the ATM over a period of time.

14. The method as claimed in claim 1, wherein:
the query is a query for a total amount of currency in the ATM; and
outputting data includes outputting the total amount of currency in the ATM.

15. The method as claimed in claim 1, wherein:
the receptacle is one of at least two receptacles of the ATM; and
the query is a query for a total amount of currency in each of the at least two receptacles of the ATM; and
outputting data includes outputting data representative of the total amount of currency in each of the at least two receptacles.

16. The method as claimed in claim 1, wherein the currency is one of cash, stamps, and tickets.

17. The method as claimed in claim 1, wherein the first and second data represent a net amount of currency dispensed from the ATM.

18. The method as claimed in claim 1, wherein the first and second data represent an amount of currency remaining in the ATM.

19. The method as claimed in claim 1, wherein the first and second data include data identifying the ATM.

20. The method as claimed in claim 19, wherein the data identifying the ATM includes location information of the ATM.

21. The method as claimed in claim 1, wherein the second data includes data identifying the user from which the transaction is requested.

22. The method as claimed in claim 1, wherein:
the processor is a processor of a service provider;
the query is received from a computer of a customer of the service provider; and
the computer is remote from the processor of the service provider.

23. A method of managing an ATM, comprising:
receiving multiple transaction requests at the ATM;
changing an amount of currency in the ATM in response to at least some of the multiple transaction requests;
receiving data corresponding to a plurality of different currency amounts from the ATM over a period of time, wherein the plurality of different currency amounts are each greater than zero;
receiving a query for an amount of currency in the ATM at a given time in the period of time; and
outputting data representative of the amount of currency in the ATM at the given time, the amount of currency being one of the plurality of different currency amounts.

24. The method as claimed in claim 23, wherein the given time is a present time.

25. The method as claimed in claim 23, wherein the given time is a past time.

26. The method as claimed in claim 23, further comprising receiving data representative of the currency existing in the ATM at the given time.

27. The method as claimed in claim 26, wherein the data representative of the currency existing in the ATM at the given time is received from the ATM after receiving the query.

28. The method as claimed in claim 26, further comprising storing the data corresponding to the plurality of different currency amounts in a memory.

29. The method as claimed in claim 28, wherein the data corresponding to the plurality of different currency amounts is stored at a plurality of different times corresponding to different transactions at the ATM.

30. The method as claimed in claim 28, wherein the data corresponding to the plurality of different currency amounts is stored at a plurality of different times following transactions at the ATM.

31. The method as claimed in claim 28, wherein the data representative of the currency existing in the ATM at the given time is received from the memory.

32. The method as claimed in claim 23, wherein the query is part of a query for data representing a history of currency amounts in the ATM.

33. The method as claimed in claim 32, wherein:
the query for data is a query for data representing a history of currency amounts in the ATM over a plurality of successive transactions performed by the ATM; and
outputting data includes outputting data representative of the amount of currency in the ATM following each transaction in the plurality of successive transactions.

33. The method as claimed in claim 32, wherein:
the query for data is a query for data representing a history of currency amounts in the ATM over a period of time; and
outputting data includes outputting data representative of the amount of currency in the ATM over the period of time.

34. The method as claimed in claim 23 for use in managing a plurality of ATMs, the method further comprising:
receiving multiple transaction requests at each of the plurality of ATMs;
changing amounts of currency in the plurality of ATMs in response to at least some of the multiple transaction requests at the plurality of ATMs;
receiving data corresponding to a plurality of different currency amounts from each ATM over a period of time, wherein the plurality of different currency amounts are each greater than zero;
receiving a query for an amount of currency in at least one of the plurality of ATMs at a given time in the period of time; and
outputting data representative of the amount of currency in the at least one of the plurality of ATMs at the given time, the amount of currency being one of the plurality of different currency amounts.

35. The method as claimed in claim 34, wherein the query is part of a query for data representing a history of currency amounts in at least some of the plurality of ATMs.

36. The method as claimed in claim 23, wherein:
the ATM has a plurality of receptacles in which currency is retained;
changing an amount of currency includes changing amounts of currency in the plurality of receptacles in response to at least some of the multiple transaction requests;
receiving data includes receiving data corresponding to a plurality of different currency amounts in the plurality of receptacles over a period of time, wherein the plurality of different currency amounts are each greater than zero; and
outputting data includes outputting data representative of the amounts of currency in the plurality of receptacles at the given time.

37. The method as claimed in claim 37, wherein the currency is at least one of cash, stamps, and tickets.

38. The method as claimed in claim 23, wherein the data corresponding to a plurality of different currency amounts is representative of amounts of currency dispensed from the ATM.

39. The method as claimed in claim 38, wherein:
the data corresponding to a plurality of different currency amounts is represented as a plurality of negative numbers; and
the different amounts of currency are greater than zero.

40. The method as claimed in claim 23, wherein the data corresponding to a plurality of different currency amounts is representative of currency amounts remaining in the ATM.

41. The method as claimed in claim 23, further comprising receiving data identifying the ATM with the data corresponding to the plurality of different currency amounts.

42. The method as claimed in claim 41, wherein the data identifying the ATM includes location information of the ATM.

43. The method as claimed in claim 23, further comprising receiving data identifying users of the ATM with the data corresponding to the plurality of different currency amounts.

44. The method as claimed in claim 23, wherein:
the data corresponding to a plurality of different currency amounts is received by a processor of a service provider servicing the ATM;
the query is made by a computer of a customer of the service provider;
the computer of the customer is remote from the processor of the service provider; and
outputting data representative of the amount of currency in the ATM includes sending the data representative of the amount of currency in the ATM from the processor of the service provider to the computer of the customer.

45. A system for managing an ATM, the system comprising:
a processor adapted to be coupled to the ATM for receiving data from the ATM, wherein the data corresponds to a plurality of different currency amounts in the ATM, the plurality of different currency amounts including a range of currency amounts between an empty currency amount and a full currency amount;
a memory associated with the processor, wherein the processor is configured to store the data received from the ATM in the memory; and
a user interface operable with the processor, the user interface operable to accept a query from a user for data corresponding to at least one of the plurality of different currency amounts and to output data corresponding to the at least one of the plurality of different currency amounts to the user.

46. The system as claimed in claim 45, wherein the data corresponding to the plurality of different currency amounts in the ATM is a plurality of different currency amounts in the ATM over a period of time.

47. The system as claimed in claim 46, wherein the processor is configured to receive and store data corresponding to each of the different currency amounts during each transaction performed by the ATM.

48. The system as claimed in claim 46, wherein the processor is configured to receive and store data corresponding to each of the different currency amounts after each transaction performed by the ATM.

49. The system as claimed in claim 46, wherein the processor is configured to receive and store data corresponding to each of the different currency amounts during at least some transactions performed by the ATM.

50. The system as claimed in claim 45, wherein the processor is responsive to a query for a history of currency amounts in the ATM by retrieving a plurality of currency amounts from the memory corresponding to parameters of the query.

51. The system as claimed in claim 50, wherein the parameters of the query are a number of successive transactions performed by the ATM.

52. The system as claimed in claim 51, wherein the parameters of the query are all transactions performed by the ATM over a period of time.

53. The system as claimed in claim 45, wherein:
the processor is adapted to be coupled to a plurality of ATMs for receiving data from the ATMs;
the data corresponds to a plurality of different currency amounts in the ATMs, the plurality of different currency amounts each including a range of currency amounts between an empty currency amount and a full currency amount;
the processor is configured to store the data received from the ATMs in the memory; and
the user interface is operable to accept a query from a user for data corresponding to at least one of the plurality of different currency amounts of the ATMs and to output data corresponding to the at least one of the plurality of different currency amounts of the ATMs to the user.

54. The system as claimed in claim 53, wherein the processor is responsive to a query for a history of currency amounts in at least two ATMs by retrieving a plurality of currency amounts from the memory corresponding to parameters of the query.

55. The system as claimed in claim 45, wherein:
the ATM has at least two receptacles within which currency is received; and
the data received from the ATM corresponds to amounts of currency in the at least two receptacles.

56. The system as claimed in claim 45, wherein the processor is responsive to a query for a current amount of currency in the ATM by retrieving from the memory data corresponding to a most recent currency amount received by the processor.

57. The system as claimed in claim 55, wherein the processor is responsive to a query for a current amount of currency in each of the at least two receptacles by retrieving from the memory data corresponding to most recent currency amounts received by the processor.

58. The system as claimed in claim 45, wherein the ATM is adapted to retain currency in the form of at least one of cash, stamps, and tickets.

59. The system as claimed in claim 45, wherein the data output by the user interface is representative of an amount of currency dispensed by the ATM.

60. The system as claimed in claim 45, wherein the data output by the user interface is representative of an amount of currency remaining in the ATM.

61. The system as claimed in claim 45, wherein the processor is responsive to the query from the user by retrieving from the memory data identifying the ATM.

62. The system as claimed in claim 61, wherein the data identifying the ATM includes data identifying a location of the ATM.

63. The system as claimed in claim 45, wherein the processor is responsive to the query from the user by retrieving from the memory data identifying at least one transaction performed at the ATM.

64. The system as claimed in claim 63, wherein the data identifying at least one transaction performed at the ATM includes data identifying a user of the ATM in each transaction.

65. The system as claimed in claim 45, wherein:
the processor is a processor of a service provider for the ATM;
the user is a customer of the service provider; and
the user interface is a user interface of the customer, the user interface at least partially defining a computer of the customer remote from the service provider,
the processor responsive to the query from the customer by sending data corresponding to the at least one of the plurality of different currency amounts to the user interface of the customer.

66. A method of managing an ATM, comprising:
providing a processor configured to establish communication with at least one courier service and with at least one ATM;
retrieving data corresponding to at least one courier service, wherein the data includes courier information and schedule information of the courier;
sending from the ATM to the processor at least one of data corresponding to currency amounts in the ATM and status signals corresponding to ATM operation;
updating the schedule information of the courier in response to at least one of the data received and the status signals received by the processor; and
sending the updated schedule information from the processor to the at least one courier.

67. The method as claimed in claim 66, wherein retrieving data corresponding to the at least one courier service includes retrieving courier information and schedule information of the courier from a memory coupled to the processor.

68. The method as claimed in claim 66, wherein retrieving data corresponding to the at least one courier service includes sending courier information and schedule information of the courier from a computer of the courier to the processor.

69. The method as claimed in claim 66, further comprising saving in a memory coupled to the processor the at least one of data corresponding to currency amounts in the ATM and status signals corresponding to ATM location.

70. The method as claimed in claim 66, further comprising displaying the schedule information of the courier, wherein updating the schedule information includes inputting changes to a courier schedule via a user interface coupled to the processor.

71. The method as claimed in claim 66, wherein updating the schedule information of the courier occurs automatically responsive to sending the at least one of data corresponding to currency amounts in the ATM and status signals corresponding to ATM operation.

72. The method as claimed in claim 66, wherein:
the processor is a host computer of a service provider configured to establish communication with at least one customer's computer;
data corresponding to the at least one courier service is retrieved by the at least one customer's computer; and
the schedule information of the courier is updated by the customer at the customer's computer; the method further comprising:
sending from the processor to the customer's computer the at least one of data corresponding to currency amounts in the ATM and status signals corresponding to ATM operation; and
sending the updated schedule information from the customer's computer to the processor.

73. The method as claimed in claim 66, wherein the data corresponding to currency amounts in the ATM includes data representative of the total currency in the ATM.

74. The method as claimed in claim 66, wherein:
the ATM has at least two receptacles within which currency is retained; and
the data corresponding to currency amounts in the ATM includes data representative of the total currency in the at least two receptacles.

75. The method as claimed in claim 66, wherein the status signals corresponding to ATM operation include a signal indicating whether the ATM is operational.

76. The method as claimed in claim 66, wherein updating the schedule information of the courier includes changing at least one of a time, day, and date of courier service of the ATM.

77. The method as claimed in claim 66, wherein updating the schedule information of the courier includes assigning the ATM to a different route of the courier.

78. A method of balancing an ATM, the method comprising:
providing a processor adapted to be coupled to an ATM;
sending data corresponding to at least one currency amount in the ATM from the ATM to the processor, wherein the at least one currency amount is calculated by the ATM;
sending the data corresponding to the at least one currency amount in the ATM to a user interface for display to a user;
displaying the data to the user via the user interface;
counting at least one amount of currency retrieved from the ATM;
comparing the data corresponding to the at least one currency amount calculated by the ATM to the at least one amount of currency retrieved from the ATM; and
calculating a difference between the at least one currency amount calculated by the ATM and the at least one amount of currency retrieved from the ATM, wherein the difference is one of a negative amount, a positive amount, and zero.

79. The method as claimed in claim 78, wherein the data sent to the ATM is data representative of a total currency amount in the ATM calculated by the ATM.

80. The method as claimed in claim 78, wherein:
the ATM has at least two receptacles within which currency is received; and
the data sent to the ATM is data representative of currency totals for the at least two receptacles.

81. The method as claimed in claim 78, further comprising:
storing the data corresponding to the at least one currency amount in the ATM in a memory associated with the processor; and
retrieving the data corresponding to the at least one currency amount in the ATM from the memory associated with the processor.

82. The method as claimed in claim 78, further comprising sending additional data corresponding to a plurality of additional currency amounts in the ATM from the ATM to the processor, wherein the additional currency amounts are calculated by the ATM.

83. The method as claimed in claim 82, wherein the data corresponding to the at least one currency amount and the data corresponding to the plurality of additional currency amounts are sent to the processor following corresponding transactions performed by the ATM.

83. The method as claimed in claim 82, wherein the data corresponding to the at least one currency amount and the data corresponding to the plurality of additional currency amounts are sent to the processor during corresponding transactions performed by the ATM.

84. The method as claimed in claim 78, wherein the data corresponding to the at least one currency amount in the ATM is representative of an amount of currency dispensed from the ATM.

85. The method as claimed in claim 78, wherein the data corresponding to the at least one currency amount in the ATM is representative of an amount of currency remaining in the ATM.

86. The method as claimed in claim 78, further comprising:
sending to the processor data corresponding to at least one transaction performed by the ATM;
sending the data corresponding to the at least one transaction performed by the ATM to the user interface for display to a user;
receiving a command by the user via the user interface to display data corresponding to a selected transaction;
displaying the data corresponding to the selected transaction and an option for processing an exception for the selected transaction;
receiving a command by the user via the user interface to process an exception for the selected transaction; and
processing an exception for the selected transaction.

87. The method as claimed in claim 78, wherein:
the processor is a processor of a service provider;
the user is a customer of the service provider; and
the user interface is remote from the processor.

88. A method of determining profitability of an ATM, comprising:
providing a processor adapted to be coupled to the ATM;
sending from the ATM to the processor data representative of financial transactions performed by the ATM;
storing the data representative of the financial transactions in a memory associated with the processor;
receiving at the processor data representative of operating costs associated with operation of the ATM;
calculating a cost associated with operating the ATM for a period of time, the cost based at least in part upon the data representative of the operating costs associated with operation of the ATM;
calculating a revenue generated by the ATM for a period of time, the revenue based at least in part upon the data representative of the financial transactions; and
outputting the profitability of the ATM, the profitability based upon the calculated cost and the calculated revenue.

89. The method as claimed in claim 88, further comprising retrieving data representative of operating costs associated with operation of the ATM from another memory associated with the processor.

90. The method as claimed in claim 88, further comprising retrieving data representative of operating costs associated with operation of the ATM from the memory associated with the processor.

91. The method as claimed in claim 88, wherein the data representative of operating costs includes data representative of telecommunications costs for operating the ATM.

92. The method as claimed in claim 88, where in the data representative of operating costs includes data representative of courier costs for servicing the ATM.

93. The method as claimed in claim 88, wherein the data representative of operating costs includes data representative of costs for maintenance of the ATM.

94. The method as claimed in claim 88, wherein the data representative of operating costs includes data representative of costs of cash for the ATM.

95. The method as claimed in claim 88, wherein the data representative of operating costs includes data representative of the cost of the ATM.

96. The method as claimed in claim 88, wherein the data representative of operating costs includes data representative of ATM installation costs for the ATM.

97. The method as claimed in claim 88, wherein the data representative of operating costs includes data representative of administrative costs for operating the ATM.

98. The method as claimed in claim 97, wherein the administrative costs for operating the ATM include network fees for the ATM.

99. The method as claimed in claim 88, wherein:
the ATM performs a number of transactions over a period of time; and
the data representative of the financial transactions includes the number of transactions performed by the ATM.

100. The method as claimed in claim 88, wherein the data representative of the financial transactions includes an amount of ATM fees generated by the ATM.

101. The method as claimed in claim 88, further comprising performing the sending, storing, receiving, and both calculating steps for a plurality of ATMs to determine profitability of a group of ATMs.

102. The method as claimed in claim 88, wherein the processor is adapted to be coupled to a user interface, the method further comprising prompting a user to input via the user interface data representative of operating costs associated with operation of the ATM.
